(19) United States
(12) Patent Application Publication
(10) Pub. No.: US 2009/0128553 A1
(43) Pub. Date: May 21, 2009

(54) IMAGING OF ANATOMICAL STRUCTURES

(75) Inventors: Jamie Perry, Champaign, IL (US); David Kuehn, Champaign, IL (US); Michael S. Goldwasser, Wilmington, NC (US); Brad Sutton, Savoy, IL (US)

Correspondence Address: AKERMAN SENTERFITT, P.O. BOX 3188, WEST PALM BEACH, FL, 33402-3188, US

(73) Assignee: THE BOARD OF TRUSTEES OF THE UNIVERSITY OF ILLINOIS, Urbana, IL (US)

(21) Appl. No.: 12/268,906

(22) Filed: Nov. 11, 2008

Related U.S. Application Data
(60) Provisional application No. 60/988,258, filed on Nov. 15, 2007.

(51) Int. Cl. G06T 15/00; G06K 9/00

(52) U.S. Cl. 345/419; 382/131

(57) ABSTRACT

A system that incorporates teachings of the present disclosure may include, for example, an imaging device having a Magnetic Resonance Image (MRI) scanner to generate MRI data associated with soft tissue of a patient, and supply said MRI data to diagnostic equipment that selects one or more normative soft tissue profiles of a select anatomical section, and generates a three dimensional soft tissue image from the MRI data and the one or more normative soft tissue profiles. Additional embodiments are disclosed.

### CROSS-REFERENCE TO RELATED APPLICATIONS

The present application claims the benefit of priority to U.S. Provisional Application No. 60/988,258 filed on Nov. 15, 2007, which is hereby incorporated herein by reference.

### FIELD OF THE DISCLOSURE

The present disclosure relates generally to anatomical structures, and more specifically to imaging of anatomical structures.

### BACKGROUND

Magnetic Resonance Image (MRI) and X-ray scanners have provided physicians two dimensional as well as three dimensional imagery to diagnose illnesses or abnormalities in a patient. Some surgeons use the imagery generated by these scanners to locate an abnormality before engaging in surgery.

### BRIEF DESCRIPTION OF THE DRAWINGS

FIG. 1 depicts an illustrative embodiment of a dorsal view of the nasal surface of the velum and the major muscles of the velopharyngeal mechanism in an individual with normal anatomy including (A) levator veli palatini, (B) tensor veli palatini, (C) palatopharyngeus, (D) hamulus, and (E) musculus uvulae;

FIG. 2 depicts an illustrative embodiment of an midsagittal plane used to determine the angle of the oblique coronal image plane;

FIG. 3 depicts an illustrative embodiment of an oblique coronal image of a subject with cleft palate demonstrating the sling arrangement from the origin (black arrow) to the insertion (red arrow) at the posterior edge of the hard palate. The depression on one side of the tongue is caused by the oxygen tube;

FIG. 4 depicts an illustrative embodiment of an oblique coronal image of a subject without cleft palate demonstrating the sling arrangement from the origin (black arrow) to the insertion (red arrow) at the midline of the velum;

FIG. 5 depicts an illustrative embodiment of an oblique coronal image of subject with unrepaired cleft palate demonstrating the measurements for the distance between origins, length of levator muscle, and angle of origin;

FIG. 6 depicts an illustrative embodiment of a schematic of the right levator muscle bundle angle of origin in the oblique coronal image plane. The dotted line represents the base of the skull and connects the origin points of the two levator bundles. “O” stands for the muscle origin and “I” is muscle insertion;

FIG. 7 depicts an illustrative embodiment of a levator muscle in adult male subjects reported in Ettema et al., 2002. The black line courses through the body of the levator muscle. The white arrow is pointing to the change in course of the muscle, which in the adult normal mechanism forms an obtuse angle before diverging towards the midline. (FIG. 4 in Ettema et al., 2002);

FIG. 8 depicts an illustrative embodiment of an oblique coronal image of Subject 3 before primary palatoplasty demonstrating an inverted muscle bend (black arrow). The dotted line courses through the length of the levator muscle;

FIG. 9 depicts an illustrative embodiment of a schematic of the right levator muscle bundle angle of origin in the oblique sagittal image plane. The dotted line represents the base of the skull and is orthogonal to the dotted line shown in FIG. 34. “I” stands for the muscle origin and “I” is muscle insertion;

FIG. 10 depicts an illustrative embodiment of an oblique coronal image (seen as line running through sagittal image) overlaid onto the midsagittal MR image. The arrow points to the cribriform plate which was used to determine the location of the reference line;

FIG. 11 depicts an illustrative embodiment of an oblique coronal image overlaid onto the midsagittal image. The white line courses through the cribriform plate and is used as a reference line to obtain the angle measure (arrow points to the location where the angle measure was obtained);

FIG. 12 depicts an illustrative embodiment of an oblique coronal image of the levator muscle demonstrating the placement used to measure the muscle thickness (red lines) in subjects without a cleft palate and those with a repaired cleft palate. The black arrows point to the muscle bend or the placement of the thickness measurements;

FIG. 13 depicts an illustrative embodiment of an oblique coronal image of the levator muscle demonstrating the placement used to measure the muscle thickness (red lines) in subjects with an unrepaired cleft palate. The arrows point to the measurement location;

FIG. 14 depicts an illustrative embodiment of a sagittal image used as the reference image to identify the knee of the velum in a subject with an unrepaired cleft palate. The orange line represents the axial plane which is positioned at the level of the hard palate;

FIG. 15 depicts an illustrative embodiment of an axial image overlaid onto the sagittal reference image;

FIG. 16 depicts an illustrative embodiment of an axial image overlaid onto the sagittal reference image. The anterior to posterior dimension was obtained by measuring the distance from the dorsal aspect of the velar knee to the posterior pharyngeal wall;

FIG. 17 depicts an illustrative embodiment of an Amira interface demonstrating the surface generations created from the segmented MRI data;

FIG. 18 depicts an illustrative embodiment of a Maya image demonstrating the changes that were made to the adult skull model to resemble the skull of an infant with a cleft palate;

FIG. 19 depicts an illustrative embodiment of a Maya image of the imported Amira skull model (left) compared to the created Maya model (right);

FIG. 20 depicts an illustrative embodiment of a Maya model of the mucosa of the unilateral cleft lip and palate. The purple solid color represents the Amira segmented data. The transparent white mucosa is the Maya model which is designed to fit the contours of the segmented Amira data;

FIG. 21 depicts an illustrative embodiment of an axial image overlaid onto the Maya pharynx model demonstrating the construction of the pharynx to fit the boundaries in the axial image set;

FIG. 22 depicts an illustrative embodiment of a Sagittal image overlaid onto the Maya pharynx model demonstrating the construction of the pharynx to fit the boundaries in the sagittal image set;

FIG. 23 depicts an illustrative embodiment of a Maya image combined with an axial image which was used to determine the distance from the dorsal most portion of the velum to the posterior pharyngeal wall;

FIG. 24 depicts an illustrative embodiment of an Amira files demonstrating the segmented surface generation of the skull and levator muscle. The levator muscle (muscle at the bottom of the image in purple) is displaced relative to the skull;

FIG. 25 depicts an illustrative embodiment of an Amira file representing the reference markers created in Amira. The yellow markers represent the reference markers which were used to facilitate manual placement of the muscle in the velopharynx;

FIG. 26 depicts an illustrative embodiment of a Maya model with an oblique coronal image overlaid onto the model. Arc tools were used to measure the angle of origin to ensure the Maya model matched the Amira measurements;

FIG. 27 depicts an illustrative embodiment of a Maya model demonstrating the axial, oblique coronal, and sagittal anatomical images in the program to help ensure the placement of surrounding anatomy;

FIG. 28 depicts an illustrative embodiment of a Isosurface of the subject with unilateral cleft lip and palate;

FIG. 29 depicts an illustrative embodiment of a photorealistic textures of the infant face from Poser 6.0;

FIG. 30 depicts an illustrative embodiment of an MRI overlaid onto the Maya model. The white arrow serves as a reference marker for the insertion of the levator muscle in subjects without a cleft palate and those with a repaired cleft palate;

FIG. 31 depicts an illustrative embodiment of an oblique coronal image of Subject 1, a 9-month-old female;

FIG. 32 depicts an illustrative embodiment of an oblique coronal image of Subject 2, a 10-month-old female;

FIG. 33 depicts an illustrative embodiment of an oblique coronal image of Subject 3a, an 8-month-old female with an unrepaired unilateral cleft lip and palate;

FIG. 34 depicts an illustrative embodiment of an oblique coronal image of Subject 3b at 15 months of age following primary repair of the palate;

FIG. 35 depicts an illustrative embodiment of an oblique coronal image of Subject 4a, a 9-month-old male with an unrepaired bilateral cleft lip and palate;

FIG. 36 depicts an illustrative embodiment of an oblique coronal image of Subject 4b, a 14-month-old male with a repaired bilateral cleft lip and palate;

FIG. 37 depicts an illustrative embodiment of a sequential axial images of Subject 4b progressing from a superior (left image) to inferior image (right image). The arrow illustrates the location of the irregular uvula proper. The breathing tube is evident as the dark band in the left side of the subject's oral cavity;

FIG. 38 depicts an illustrative embodiment of a schematic of the right levator muscle bundle angle of origin in the axial image plane. The dotted line represents the base of the skull and is the same as the dotted line in FIG. 34. “O” stands for the muscle origin and “I” is muscle insertion;

FIG. 39 depicts an illustrative method applied to the present disclosure;

FIG. 40 depicts an illustrative diagrammatic representation of a machine in the form of a computer system within which a set of instructions, when executed, may cause the machine to perform any one or more of the methodologies disclosed herein;

Table 1 depicts an illustrative embodiment of subject information. Subject age represents age at time of MRI scan with (a) representing before surgery and (b) after surgery;

Table 2 depicts an illustrative embodiment of sagittal scout images for subjects with cleft palate using 1.5 and 3 Tesla systems;

Table 3 depicts an illustrative embodiment of a 2D axial, oblique coronal, and sagittal anatomical scan for subjects with cleft palate using 1.5 and 3 Tesla systems;

Table 4 depicts an illustrative embodiment of a 3D oblique coronal anatomical scan for subjects with cleft palate using 1.5 and 3 Tesla systems;

Table 5 depicts an illustrative embodiment of sagittal scout images for Subject 1;

Table 6 depicts an illustrative embodiment of an axial 2D anatomical scan for Subject 1;

Table 7 depicts an illustrative embodiment of an axial 3D anatomical scan for Subject 1;

Table 8 depicts an illustrative embodiment of an oblique coronal 2D anatomical scan for Subject 1;

Table 9 depicts an illustrative embodiment of a sagittal (T1) scout images for Subject 2;

Table 10 depicts an illustrative embodiment of an axial (T2) 2D anatomical scan for Subject 2;

Table 11 depicts an illustrative embodiment of a coronal 2D anatomical scan for Subject 2;

Table 12 depicts an illustrative embodiment of a coronal 3D anatomical scan for Subject 2;

Table 13 depicts an illustrative embodiment of an axial 2D anatomical scan for Subject 2;

Table 14 depicts an illustrative embodiment of an oblique coronal 2D anatomical scan for Subject 2;

Table 15 depicts an illustrative embodiment of an Amira 4 Tool Description;

Table 16 depicts an illustrative embodiment of quantitative measures of the levator muscle for subjects without a cleft palate. Numbers in parentheses are the subjects' age in months at the time of imaging;

Table 17 depicts an illustrative embodiment of quantitative measures of the levator muscle for subjects with cleft palate before (a) and after (b) primary palatoplasty. Numbers in parentheses are the subjects' age in months at the time of the imaging;

Table 18 depicts an illustrative embodiment of an anterior to posterior measurements of the velopharyngeal port;

Table 19 depicts an illustrative embodiment of measures of the levator muscle displacement in Subject 3 during the surgical simulation compared to the actual displacement observed from the postsurgical computer model;

Table 20 depicts an illustrative embodiment of measures of the levator muscle displacement in Subject 4 during the surgical simulation compared to the actual displacement observed from the postsurgical computer model; and

Tables 21-24 depict an illustrative embodiment of reliability measurements of the levator muscle.

### DETAILED DESCRIPTION

One embodiment of the present disclosure entails a computer-readable storage medium having computer instructions for receiving Magnetic Resonance Image (MRI) data, identifying an anatomical section in the MRI data, selecting one or more normative soft tissue profiles associated with the anatomical section, and generating a three dimensional (3D) soft tissue image of the anatomical section from the MRI data and the one or more normative soft tissue profiles selected.

Another embodiment of the present disclosure entails generating a three dimensional (3D) image by comparing MRI data associated with an anatomical section with one or more normative profiles.

Yet another embodiment of the present disclosure entails an imaging device having an MRI scanner to generate MRI data associated with soft tissue of a patient, and supply said MRI data to diagnostic equipment that selects one or more normative soft tissue profiles of a select anatomical section, and generates a three dimensional soft tissue image from the MRI data and the one or more normative soft tissue profiles.

Structures of the Velopharyngeal Mechanism

The velopharynx is an area that functions to provide an airtight seal for adequate separation of the nasal and oral cavities during the production of oralized sounds and during swallowing (Moon & Kuehn, 2004; Perlman & Schulze-Delrieu, 1997). The major structures of the velopharynx are the velum, lateral pharyngeal walls, and the posterior pharyngeal wall. The velum extends beyond the posterior nasal border of the hard palate via the palatine aponeurosis and terminates at the tip of the uvula. The palatine aponeurosis is a thin fibrous lamella that provides support and stiffness to the velum.

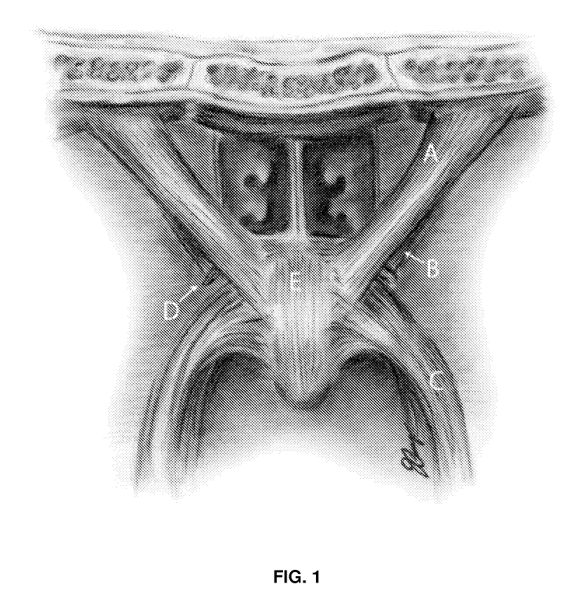

Histologic studies show that the velum consists of a mixture of tendinous, muscular, adipose, connective, and glandular tissue along the velar length (Ettema & Kuehn, 1994; Kuehn & Kahane, 1990). The anterior 2/3 of the velum appears to be consistent in its composition compared to the posterior 1/3 which shows greater variability across individuals. This demonstrates the importance of the anterior 2/3 in providing the functional components to the velum during velopharyngeal closure (Kuehn & Moon, 2005). Some children may rely on an enlarged adenoid pad and/or Passayant's ridge to create velopharyngeal closure (Finkelstein, Gerger, Nachmani, & Ophir, 1996). The muscles of the velopharynx include the tensor veli palatini, levator veli palatini, musculus uvulae, salpingopharyngeus, palatopharyngeus, and palatoglossus (FIG. 1).

The tensor veli palatini is a thin, broad, flat muscle that originates at the scaphoid fossa at the base of the medial pterygoid plate of the sphenoid bone and the lateral margins of the Eustachian tube (Abe et al., 2004; Barsoumian, Kuehn, Moon, & Canady, 1998). The bulk of the muscle lies between the medial and lateral pterygoid plates in the pterygoid fossa. The fibers course inferior-anteriorly and end in the tensor tendon that wraps around the hamulus and inserts into the palatine aponeurosis. The hamulus acts as a pulley to assist the tensor veli palatini in providing tensile properties to the palatine aponeurosis and velum (Abe et al., 2004). The anteriormost fibers of the tensor tendon insert onto the posterior region of the hard palate (Kuehn & Kahane, 1990). It is suggested that this helps to relieve stress and functions as a hinge between the hard palate and velum.

The primary function of the tensor veli palatini is to open the Eustachian tube to allow for equalization of pressure between the middle ear cavity and nasopharynx (atmospheric pressure). In individuals born with a cleft palate, the tensor veli palatini inserts onto the bony aspects of the cleft, including the maxillary tuber and pterygoid process. Typically, primary palatal surgery does not restore correct positioning of this muscle, which may contribute to poor auditory tube functioning and decreased ventilation of the tympanic cavity (Abe et al., 2004). It is generally agreed that the tensor veli palatini does not contribute to velar elevation during speech production (Fritzell, 1969; Kuehn & Kahane, 1990).

The levator veli palatini (levator muscle) appears to have the most significant impact on velar elevation (Huang, Lee, & Rajendran, 1998). It is in a favorable position to elevate and retract the velum. The levator muscle is a thick rounded muscle that originates at the base of the skull, specifically the petrous portion of the temporal bone and from the medial lamina of the Eustachian tube cartilage. It courses anteriorly, inferiorly, and medially to insert into the middle 40-50% of the body of the velum forming a sling with the opposing levator muscle bundles (Mehendale, 2004).

There is no septum between the two levator bundles in the midline (Kuehn & Moon, 2005). There is little variability across individuals in the size, shape, and location of the levator muscle bundles in normal adult males and females (Ettema et al., 2002). In individuals born with a cleft palate the levator fibers do not come to the midline, rather they course more anteriorly to insert into the hard palate, along the medial borders of the palatal cleft resulting in a different insertion location (Peterson-Falzone, Hardin-Jones, & Karnell, 2001).

The musculus uvulae lies along the middle of the nasal surface of the velum. It is surrounded by a capsule consisting of a thin connective tissue sheath (Kuehn & Moon, 2005). The capsule extends into the lowermost portion of the uvula. The muscle fibers within the capsule gradually dissipate and become less cohesive towards the distal end of the uvula (Azzam & Kuehn, 1977; Kuehn & Moon, 2005). Kuehn and Moon (2005) found that in some individuals a septum separated both muscle bundles along the midline of the velum whereas in others there was no clear boundary between both muscle bundles.

The musculus uvulae is thought to add bulk to the dorsal midline surface of the velum. This added bulk may help to close the gap between the velum and the posterior pharyngeal wall during speech production (Kuehn, Folkins, & Linville, 1988). Because this muscle lies in the midline of the velum, a cleft of the hard and soft tissues may cause the musculus uvulae to be reduced in size or absent. This would suggest that even a repaired palatal cleft may be functioning at a disadvantage compared to that of individuals with normal velopharyngeal anatomy.

The salpingopharyngeus muscle arises from the inferior border of the torus tubarius and extends inferiorly through the salpingopharyngeal fold to insert into the lateral pharyngeal walls. This muscle is small and has few notable contributions to speech and velar movement. Variability of the muscle mass and size has been reported across individuals (Dickson & Dickson, 1972). The salpingopharyngeus muscle may function to pull the lateral pharyngeal walls superiorly to assist in swallowing gestures. However, it appears to have little significant impact on movements during speech production.

Within the oral cavity lie two important muscles that appear to have an influence on velar movement. Contraction of the palatopharyngeus and palatoglossus in combination with velar elevation via the levator muscle function conjunctively to provide velar positioning (Moon, Smith, Folkins, Lemke, & Gartlan 1994; Seaver & Kuehn, 1980). The palatopharyngeus muscle arises from the lateral margins of the velum and diverges inferiorly to insert into the pharyngeal wall. Cassell, Moon, and Elkadi (1990) define two parts to each muscle bundle as the palatothyroideus and palatopharyngeus proper.

The palatothyroideus fibers course vertically within the posterior faucial pillars and terminate on the greater horn of the thyroid cartilage. The palatopharyngeus proper courses transversely and terminates along the lateral pharyngeal walls. Although most literature supports the notion that this muscle is more active during swallowing compared to speech, the palatothyroideus fibers appear to be in position to be an antagonist to the levator muscle (Moon et al., 1994; Seaver & Kuehn, 1980; Trigos, Ysunza, Vargas, & Vazquez, 1988). The transverse fibers may function to pull the lateral pharyngeal walls medially during velopharyngeal closure (Cassell et al., 1990).

More anteriorly relative to the palatothyroideus lies the palatoglossus muscle. This muscle courses from the lateral margins of the velum to the lateral sides of the tongue body. The muscle is contained within the anterior faucial pillar. Contraction of the palatoglossus muscle may assist in pulling the tongue upward and backward. In relation to the velum, it may work collectively with the palatothyroideus to provide antagonistic properties to the levator muscle by maintaining a lowered velar position. Elastic fibers within the anterior faucial pillar may provide a passive restoration effect on the velum to help lower the palate and open the velopharyngeal port (Kuehn & Azzam, 1978). The attachment of the palatoglossus and palatopharyngeus muscles, like the levator muscle, is more anterior along the hard palate in individuals with a cleft palate.

At the level of the velopharyngeal port the pharyngeal muscles, the superior pharyngeal constrictor and middle pharyngeal constrictor, overlap to provide medial and anterior movement of the upper lateral and posterior pharyngeal walls (Huang et al., 1998; Perlman, Luschei, & Du Mond, 1989). These movements are important during velar elevation because they assist in providing a tight seal between the velum and the posterior pharyngeal wall. Some fibers of the superior pharyngeal constrictors diverge anteriorly beyond the posterior pharyngeal raphe and insert into the velum functioning to assist in velar retraction (Kuehn, 1979). These fibers in combination with the transverse fibers of the palatopharyngeus may also contribute to formation of a Passayant's ridge if present (Kuehn and Perry, 2007). In individuals with a cleft palate, the superior pharyngeal constrictor muscle is typically not consistently affected or altered as a result of the cleft palate.

Aside from abnormal muscle positioning found in individuals with a cleft palate, complications are also present due to the existence of a cleft palate. The oral and nasal cavities are coupled due to the congenital cleft formed in the hard palate and velum. Problems related to feeding, maxillary facial growth, dentition, hearing, and speech are just a few of the obstacles these children and their families will encounter throughout the child's life. A child born with a cleft palate may undergo multiple surgeries to restore anatomy and gain levator muscle function. Even after surgical repair of the cleft palate, children often continue to have an inadequate speaking mechanism.

Primary Palatoplasty

The goal of primary palatoplasty is to create separation between the oral and nasal cavities. A typical practice in the United States is to perform surgery prior to 18 months of age. During surgery, the levator muscle fibers are commonly dissected off the hard palate and retropositioned to form a sling across the middle 50% of the velum. Adequate bulk through the midline will help increase the efficiency of the muscle during contraction. Kock, Grzonka, and Kock (1999) observed a malpositioned and folded palatal aponeurosis in individuals born with a cleft palate. The researchers suggest that primary repair of the palate not only include retropositioning of the levator muscle but also reconstruction of fibers of the palatal aponeurosis.

Cutting, Rosenbaum, and Rovati (1995), Mehendale (2004), and Sommerlad et al. (1994, 2002) discuss the importance of addressing the entire anterolateral fibers of the levator veli palatini muscle during dissection. Mehendale (2004) reported results from cadaver dissection of normal adults, histology, and intraoperative inspection of the anatomy in individuals with cleft palates. Movement of the isolated levator muscle was simulated in the cadaver specimens. Traction on the main mass of the levator muscle produced overall velar movement.

Traction on the anterolateral levator muscle fibers did not result in significant velar movement; rather it produced a posterior and superior direction of force on the palatine aponeurosis. In individuals with normal velopharyngeal anatomy, the anterolateral levator muscle fibers may be an antagonist to the tensor veli palatini by functioning to extend the palatine aponeurosis in an anterior posterior direction. However, in individuals with a cleft palate, the anterolateral levator fibers, if left attached to the nasal mucosa, appear to tether levator movement and compromise the movement of a retropositioned levator muscle.

Cutting et al. (1995) and Sommerlad et al. (1994, 2002) emphasize the importance of dissecting the tensor tendon lateral to the main mass of the levator muscle in the hard palate region. Sommerlad et al. (1994, 2002) discuss the use of palate re-repairs over traditional pharyngoplasty for the management of velopharyngeal inadequacy (VPI). In such, the palatine aponeurosis is radically dissected from the posterior border of the hard palate and then dissected off the nasal mucosa. The goal of this procedure is to remove all attached levator fibers from the hard palate. This is done so as to release tensions within the velopharyngeal region, thus allowing sufficient displacement of the velum during contraction of the levator muscle.

Even after the primary palatoplasty, the velopharynx may function abnormally resulting in a coupling effect between the oral and nasal cavities at the level of the velopharyngeal port. During speech production, this effect results in the presence of hypernasality or abnormal nasal resonance during oralized vowels and consonants. It is estimated that approximately 20-30% of individuals with cleft palate develop hypernasal speech even after primary palatal surgery (McWilliams, 1990). The existence of hypernasality may also have devastating effects on the child's quality of life. Studies have shown that children with hypernasal speech are perceived by peers to be less pleasant, attractive, intelligent, and outgoing compared to individuals with normal speech (Landsdown & Polak, 1975).

Hypernasality and nasal air emission are commonly a result of VPI. Velopharyngeal inadequacy results when the velum is not able to create a tight seal against the posterior pharyngeal wall, thus the mechanism is functioning inadequately. Several reasons for VPI have been postulated and the actual cause varies across patients. In some cases, the velum may be too short to make contact against the posterior pharyngeal wall. Another reason may be because the velum is long enough, but the pharynx is too deep relative to other surrounding structures. In this case, surgery may provide normal functioning of the velum, however, contact against the posterior pharyngeal wall would still be compromised due to the deep pharynx. A visual oral inspection and lateral view x-ray can be used to identify when the velum is short or the pharynx is deep relative to the surrounding structures.

A third cause of VPI is due to faulty positioning or improper dissection of the levator muscle during primary palatoplasty. In such cases, the levator muscle fibers may not be fully dissected off the hard palate. Upon contraction, the levator fibers may tense but posterior movement is restricted due to the aforementioned tethering effect caused by the anteriorly attached fibers. Another cause may be a disparity of levator sling fibers through the body of the velum. Kuehn, Ettema, Goldwasser, and Barkmeier (2004) suggest the possibility of muscle position relapse. In such cases, the levator sling may have been surgically positioned correctly, however, with time the muscles may have drifted more anteriorly towards an unfavorable position.

As a result, several assumptions arise in regard to muscular repositioning during primary palatoplasty. Unless visual inspection of the levator muscle through medical images (such as magnetic resonance images) is used during a patient's clinical treatment, the surgeon cannot always be certain that all the fibers have been relocated to the appropriate position. Even if the muscle is repositioned correctly, adequate levator muscle mass through the midline of the velum may or may not be achieved.

There is a lack of data regarding what constitutes adequate mass through the midline. This may be due to two factors. First, the use of MRI for studying the levator muscle is relatively new. Most imaging studies to date do not include inspection of the levator muscle in vivo. Secondly, when viewing an oblique coronal MR image, it is difficult to differentiate the levator muscle from the musculus uvulae. Huang et al. (1998) found variability among levator muscle insertion into the velum in individuals without a cleft palate, which would affect the leverage of the sling. These variations might account for the velar component of different closure patterns found among speakers.

It is unclear, however, what amount of variability in the angle of insertion, length of the levator muscle, and distance between origins is acceptable for adequate velopharyngeal closure. Additionally, whether a cleft palate affects these parameters of the muscular sling is not known. No studies have examined how the reconstructed soft tissue responds to external forces or whether the muscle might with time migrate towards a less favorable position. These are assumptions that imaging, particularly magnetic resonance imaging (MRI), can help overcome.

Further research is needed to fully understand the mechanics of the levator muscle in coordination with surrounding structures in individuals born with a cleft palate. Additional research is needed in the area of surgical intervention for children born with a cleft palate. A major drawback to current surgical practices is that there is limited presurgical planning. Most methods include inspection of 2D data, such as lateral view x-ray. Traditional lateral view x-ray does not allow the surgeon to visualize the levator muscle before surgery. In addition, information from 2D data tends to simplify the complexity and variability of the internal anatomy (Perry, Kuehn, & Langlois, 2007). Surgical follow-up using imaging modalities such as MRI is uncommon MRI is the only imaging technique currently available that enables visualization of muscles in living individuals.

Imaging Investigations

To date, most investigations of the levator muscle have involved gross dissection (Huang et al., 1998; Mehendale, 2004), histologic studies (Kuehn & Kahane, 1990), computed tomography (CT), and lateral view x-ray (Finkelstein et al., 1995). There are disadvantages to using these methods to examine muscle function. Dissection presents complications due to the relative inaccessibility of the region such that tissue must be removed in order to gain access to other areas of interest (Ettema, Kuehn, Perlman, & Alperin, 2002). Histologic processes also add complications secondary to the extraction, preservation, and staining of the human tissue. Furthermore, both methods are destructive in nature and can only be done on cadaveric material. Lateral view x-ray and CT allow for study in vivo, however, are considered to place the patient at risk of exposure to radiation and muscle cannot be visualized in contrast to adjacent soft tissue structures.

During the assessment, diagnosis, and treatment of individuals with a cleft palate, nasoendoscopy, x-ray, and videofluoroscopy tend to be the most commonly reported methods. Nasoendoscopy uses a fiberoptic flexible probe inserted through the nasal cavity to view the cranial or top view of the velopharyngeal port. Using nasoendoscopy, velar movement and medial-anterior pharyngeal wall movement can be observed. Videofluoroscopy provides a motion x-ray of the velar and pharyngeal wall movement. Images can be obtained in the sagittal plane and/or frontal providing details of the anterior-posterior velar movement and anterior and medial pharyngeal wall movement. Neither of these procedures, however, allows the examiner to visualize underlying muscles including the levator muscle fibers. Although nasoendoscopy does not expose the patient to radiation, unlike CT and x-ray, it is not always tolerable for young patients. In addition, inspection of the mechanism is limited to the velopharyngeal port (e.g. closure patterns, closure gaps, and pharyngeal wall movement).

Magnetic resonance imaging has gained interest due to its ability to overcome such limitations to some extent. Ettema et al. (2002) provide a detailed review of previous work related to MRI. Magnetic resonance imaging has been used to study the vocal tract (Baer, Gore, Gracco, & Nye, 1991; Greenwood, Goodyear, & Martin, 1992; Dang and Honda, 1997; Narayanan, Alwan, & Haker, 1997). There is a limited amount of previous work in using MRI to study and measure the velopharyngeal mechanism. Some of the earliest studies using MRI to measure the velopharyngeal movements focused on the movement patterns of the velum, velopharyngeal sphincter, and velum and tongue coordination rather than the levator muscle (McGowan, Hatabu, Yousem, Randall, & Kressel, 1992; Wein, Drobnitzky, Klajman, & Angerstein, 1991; Yamawaki, Nishimura, Suzuki, Sawada, & Yamawaki, 1994).

Vadodaria, Goodacre, and Anslow (2000) discuss the possible applications of using MRI to study palatal function. The study demonstrates scanning planes that can be used and the type of information that can be obtained from these planes of view such as velopharyngeal closure, posterior pharyngeal wall movement, and velar lift. The study highlights the use of MRI to identify the levator muscle bundles in the coronal plane. The present disclosure discusses future possibilities of MRI including investigating VPI, guiding speech therapy, and planning surgical repair.

Recent work in MRI has been to investigate the specifics of the levator muscle. Kuehn, Ettema, Goldwasser, Barkmeier, and Wachtel (2001) imaged two children at four years of age who exhibited hypemasal speech. It was suspected that these children had an occult submucous cleft palate. The present disclosure demonstrates the use of MRI to diagnose the occult submucous cleft palate and to direct behavioral and surgical management. The MRI provided information about the levator muscle integrity including any disruption in the musculature, site of levator attachment, general nature of the tissue composition (i.e. glandular, fibrous, or connective tissue), and the relative size of the levator muscle. This study proved that MRI is an effective imaging tool in identifying an occult submucous cleft palate and the abnormal levator muscle insertion before surgery.

Ettema et al. (2002) reported the first quantitative measures of the levator muscle during rest and speech production. Ten adults (five females, five males) between 21 and 53 years of age with a normal velopharyngeal mechanism participated in the study. Two-dimensional spin echo static images and dynamic fast gradient echo MRI scans of the sagittal and oblique coronal planes were used to study the levator muscle at rest and during speech tasks. Measures included muscle length, thickness, distance between origins, and the angle of origin. The average length of the levator muscle was 44.7 mm for women and 45.8 mm for men.

Average thickness measures of the levator muscle just lateral to the midline of the velum were 5.4 mm for both men and women. The average angle created from the base of the skull and the converging muscle bundles at rest was 64.5 degrees for women and 60.4 degrees for men. During velar elevation, the angle of levator origin was found to decrease and levator length decreased by 19% on average across all subjects. Overall, there was no significant amount of variability on all measure from one subject to the next within each gender category, although the study size may have been too small to show signs of differences.

A similar study was conducted to compare the levator muscle in adult males and females with a history of cleft palate (Ha, Kuehn, Cohen, & Alperin, 2007). Five males and one female were imaged using MRI at rest and during speech production. The levator muscle was found to be shorter and thinner compared to the normative measures reported by Ettema et al. (2002). The angles of origin were more variable across subjects compared to the reported normative measures. In particular, males tended to have a larger angle of origin compared to normal. During speech production, the length and angle of origin changed in a similar fashion as reported among the subjects used for the Ettema et al. (2002) study. The results of the Ha, Kuehn, Cohen, and Alperin (2007) study serve as preliminary data in investigating the differences in the levator muscle in individuals with cleft palate compared to individuals without a cleft palate.

Kuehn et al. (2004) imaged the levator muscle before and after primary palatoplasty. Seven infants with cleft palate (three males, four females) and one two-month-old infant without a cleft palate participated in the study. Infants with cleft palate varied in type of cleft palate. Magnetic resonance images were obtained between 5 days and 2 months prior to surgery and 2 to 15 months after surgery. A 1.5 Tesla system was used to obtain sagittal and oblique coronal section planes for all subjects. The study provided both quantitative and qualitative detail of the levator muscle at rest. Quantitative information focused mainly on the angle of the sectioned plane, which was indicative of the steepness of the muscle as it diverges toward the insertion.

Qualitative information included levator midline bulk postoperatively, muscle continuity following surgery, orientation and direction of the levator fibers before and after surgery, and the angle of insertion into the palate (i.e., steepness of the fibers). Overall, it was found that the course of the muscle following surgery might be drastically changed making the muscle bundles steeper. This is advantageous in providing proper leverage for the velum during elevation. The present disclosure describes how MRI can be used as a prognostic indicator prior to surgery. Some noted limitations of the study include the use of 2D verses 3D acquisition, static imaging verses dynamic imaging, and only two MRI sessions versus three or more to provide information related to possible muscle relapse.

Kuehn et al. (2004) demonstrated the feasibility of imaging infants before and after primary palatoplasty. There are numerous advantages to advancing this study to include additional quantitative measurements of the levator muscle as done in the Ettema et al. (2002) study. In addition, the use of a 3D computer reconstruction would allow for increased presurgical planning with the surgical team. The ability to combine recent studies (Ettema et al., 2002; Kuehn et al., 2004) with advanced computer technology will provide advancements to studying the specifics of the levator muscle in infants born with a cleft palate.

Use of 3D Computer Modeling and Animation in Assessment, Diagnosis, and Treatment

The use of computer modeling and animation for the purpose of visualization is a new concept, particularly in the area of cleft lip and palate. To better understand the biomechanics of human anatomy, three-dimensional (3D) computer models based on computerized tomography (CT) and histology have been created to study the heart, vocal tract, and Eustachian tube (King & Parent, 2005; Nakasima et al., 2005; Spauwen, Hillen, Lommen, & Otten, 1991; Villamil, Nedel, Freitas, & Maciel, 2005). These models have been constructed using MRI, CT, and histology and are created to show overall morphologic changes to a structure, rather than looking at a specific soft tissue structure (i.e., muscle). In the field of speech science, limited research has been done to image and construct a 3D model of the velopharyngeal mechanism. There are few accurate models of the soft tissue structures of the velopharyngeal mechanism (Berry, Moon, & Kuehn, 1999; Perry & Kuehn, 2007). This may be due to the lack of accessibility of the region as well as the imaging modalities commonly used.

Cutting, Oliker, Haring, Dayan, and Smith (2002) reported the use of 3D computer graphics and animations to illustrate cleft lip and palate surgery. The computer reconstructions were created using dense CT scans of two Chinese children prior to surgery and an animation package (Maya by Alias/Wavefront, Toronto, Ontario, Canada) combined with surgical tool plugins. The animations are useful for illustrating the numerous steps in surgical maneuvers. However, a limitation of computer generated models is the difficulty in simulating soft tissue deformations. The data obtained from the CT scans is restricted to hard tissue structures (e.g. skull and hard palate) and minimal soft tissue structures (e.g. tongue and velum).

In addition, the CT scans were taken before primary palatoplasty. As a result, the computer modeling that is based on CT data only demonstrates preoperative structures. The movements, therefore, of the surgical simulations are not based on imaging data (e.g. CT or MRI). Musculature displayed in the animation was not supported by real data. By integrating MRI into computer modeling, such as that proposed by Cutting et al. (2002), the levator muscle can be qualitatively and quantitatively measured and accurately represented in three-dimensions. In addition, a postoperative model based on imaging data (e.g. MRI) would provide accurate detail of the specific hard and soft tissue movements as a result of surgery.

Three-dimensional computer models and animations of the velopharyngeal mechanism are valuable for several reasons. Investigations using 2D data may tend to reduce the complexity and variability of the velopharyngeal mechanism (Perry & Kuehn, 2006). With a 3D model, perspectives, views, and angles can be achieved that cannot be seen with other imaging technology. In addition, the flexibility of the model allows the viewer to determine the complexity of the view, removing or adding surrounding structures (e.g. tongue, teeth, skull, etc.) to gain the optimal perspective. Surrounding structures can be made transparent to allow the viewer to appreciate the interconnectivity of the anatomy while focusing on a particular region of interest, such as the levator muscle. An accurate 3D model would also enable one to simulate variability within the structures, such as in individuals born with a cleft palate. During surgical planning, this information could allow the surgeon to simulate the effects of static and dynamic forces to improve surgical prognosis.

A 3D computer model of the facial skeleton was created in Japan and used to demonstrate the feasibility of using the model during presurgical planning for oral surgery (Nakasima et al., 2005). Carter, Friedman, and Bischoff (2005) created a complete geometric data set for craniofacial reconstructions for the purpose of creating real-time computer assisted technology that can be used in the operating room. Computer models show only hard tissue structures of the cranial and facial regions. The present disclosure discusses the advantages of 3D computer models in the clinical realm such as reducing human error during surgery, presurgical planning, as well as patient specific modeling, diagnosing, and treatment.

Advantages of 3D Computer Modeling Based on MRI

A 3D computer model based on MRI data of an infant before and after primary palatoplasty provides numerous advancements in the areas of teaching, basic research, and clinical applications. The velopharyngeal mechanism is often difficult for students to conceptualize. The structures are deep and musculature is typically represented in most textbooks through 2D drawings and cadaver dissections. While exploration of the velopharyngeal mechanism through cadaver dissection would provide the most rewarding learning experience, it is not always available due to time and money constraints (Perry, Kuehn, & Langlois, 2007). In both cadaver dissection and textbooks, the perspectives provided are viewed only by removing other surrounding structures.

By using a 3D computer model, an understanding of internal anatomy in three dimensions can be made available to scientists and physicians in general. Surrounding structures can be made semi-transparent such that the velopharyngeal anatomy can be studied within its natural environment. Researchers can manipulate the model by rotating it and viewing the muscles and structures from any angle. An appreciation of the muscle retropositioning during surgery can be viewed with precise measuring tools placed beside each muscle. In addition, a computer simulated surgical procedure can be viewed by medical residents to better understand the surgical maneuvers for primary palatoplasty.

A 3D model will have numerous implications for basic research in the area of cleft palate. Currently, a preliminary finite element model has been published (Berry, Moon, & Kuehn, 1999) and two dimensional MRI data of the levator muscle has been provided (Ettema et al., 2002). Kuehn et al. (2004) demonstrated the feasibility of using MRI on infants before and after primary palatoplasty. The present disclosure combines these areas to provide further information into the biomechanics of the velopharyngeal mechanism, specifically the levator veli palatini muscle. The reported quantitative and qualitative muscle dimensions allow for comparisons for pre and post surgery as well as between individuals with cleft palate and those without.

The clinical applications of MRI combined with 3D computer technology are primarily for patient specific imaging and modeling for presurgical planning and assessment postsurgically. Many surgical practices involve lateral view x-ray before surgery. However, this does not allow the surgeon to visualize the levator muscle before surgery. Magnetic resonance imaging is the only technique currently available that enables visualization of muscles in living individuals. Surgical follow-up using imaging modalities such as MRI is uncommon. This current situation creates several questions regarding the treatment for these children. For example, it is not known whether the muscle was correctly repositioned or what specific dimensions (e.g. muscle length, distance between origins, and angle of descent towards the velum) of the levator muscle are necessary for normal speech. No studies have examined how the reconstructed soft tissue responds to external forces or whether the muscle might with time migrate towards a less favorable position.

The present disclosure can serve to reduce the amount of surgeries a child would need, reduce human error, and create a more symmetrical facial morphology. Ultimately, improving facial morphology and creating an adequate velopharyngeal mechanism for speech purposes can reduce the negative psychosocial effects reported in children with a cleft lip and palate. The present disclosure among other things provides a means for studying and charting velopharyngeal functioning in individuals with a cleft palate as well as improving understanding of surgical intervention for babies born with a cleft palate.

Research

The present disclosure involved investigations involving qualitative and quantitative information of the velopharyngeal mechanism in infants born with cleft palate before and after primary palatopasty using magnetic resonance imaging and 3D computer technology. It was suspected that the levator veli palatini muscle morphology would be distinctly different in infants with cleft palate both before and after primary palatoplasty compared to that of infants with normal anatomy. Based on previous studies (Ha et al., 2007), it was expected that the levator muscle would be shorter, thinner, and display variable angles of origin (in all image planes). However, the levator muscle would likely be more similar to normal anatomy following surgery. The velopharyngeal port would be smaller postsurgically compared to the presurgical status due to the posterior displacement often achieved with the surgical procedure being used.

Compared to the control subjects, the velopharyngeal port opening would be more similar to normal anatomy following surgery. It was also expected that the muscle would decrease in length, demonstrate smaller angle of origin in the oblique coronal image plane, and show a larger angle of origin in the oblique sagittal image plane following surgery due to the insertion point moving posteriorly during surgery or closer to the muscle origin. The muscle would likely become steeper and show more convergence following surgery compared to the presurgical status (as seen in a smaller angle of origin in the oblique sagittal image planes).

Using computer technology, 3D computer models were generated to provide comparisons to the pre and postsurgical status in infants before and after primary palatoplasty. The computer models allowed for qualitative comparisons to the computer models of normal velopharyngeal anatomy. By using the computer models, the complex internal anatomy of the velopharyngeal mechanism and surrounding structures were visualized and qualitatively and quantitatively compared as it exists in three dimensions.

The feasibility of using computer technology combined with MRI for the purposes of presurgical planning for cleft palate repair were demonstrated. Current surgical approaches involve little surgical planning.

Participants

Four infants between 8-15 months of age were recruited among patients at Carle Foundation Hospital (Urbana, Ill.). Two infants with normal velopharyngeal anatomy (Subjects 1 and 2) and two infants with cleft lip and palate (Subjects 3 and 4) participated in the study. Subjects with a cleft palate (Subjects 3 and 4) were identified by the oral and maxillofacial surgeon at Carle Foundation Hospital. These subjects were current patients of the Carle Clinic cleft palate team. Subjects 3 and 4 were selected based on the criteria that each: 1) was scheduled to undergo primary palatoplasty for correcting the cleft palate within three months following the initiation of the study, 2) required an anatomical MRI scan for clinical evaluation of the cleft palate, and 3) was within the age range of 8-15 months desired for participation.

The selection of this age range was desired as cleft palate is often corrected during this age. To fully evaluate the structural and functional restoration during primary palatoplasty, this age range must be studied. Subjects 1 and 2 were selected based on the criteria that each: 1) was scheduled to receive an anatomical MRI examination at Carle Foundation Hospital for problems not associated with cleft palate, 2) was within the age range of 8-15 months desired for participation, and 3) had no defects or syndromes that appeared to affect the anatomy and physiology of the velopharyngeal mechanism.

Subjects with normal velopharyngeal anatomy (Subjects 1 and 2) were similar in age to the subjects with cleft palate. Subjects 1 and 2 served as controls for comparisons to the presurgical and postsurgical images taken from the cleft palate subjects. A description of each subject follows and is summarized in Table 1.

Subject 1. Subject 1, an Asian-Caucasian 9-month-old female, was being scanned to assess the internal auditory canal. The subject did not pass her hearing screening at birth and was diagnosed with a bilateral severe to profound hearing loss. The MRI scanning was also to determine if she was a candidate for a cochlear implant. The subject displayed normal craniofacial, oral, pharyngeal, and velopharyngeal anatomy. The parents reported no history of feeding or swallowing issues which might preclude velar functioning. In addition, the parents reported no family history of palatal clefts or syndromes.

Subject 2. Subject 2, a 10-month-old Caucasian female, was being scanned for recurrent episodes of seizures beginning four days prior to the MRI scanning session. The subject displayed normal craniofacial, oral, pharyngeal, and velopharyngeal anatomy. The parents reported no history of feeding or swallowing issues. The parents also reported no family history of palatal clefts, syndromes, or hearing loss. The subject passed her hearing screening at birth.

Subject 3. Subject 3, a Caucasian female, was born with a complete unilateral cleft lip and palate. Primary lip and nose surgery was conducted at 10 weeks of age. Subject 3 was 8 months of age at the time of the presurgical MRI scan and 15 months of age at the time of the postsurgical MRI scan. Primary palatoplasty was performed at 9 months of age. The subject's parents reported no family history of hearing loss or syndromes. The subject passed her hearing screening at birth. The parents reported no problems with feeding or swallowing at the time of the study. Prior to primary palatoplasty, the parents reported occasional nasal regurgitation. Position and bottle modifications were used to reduce nasal regurgitation.

Subject 4. Subject 4, a Caucasian male, was born with a bilateral cleft lip that was incomplete on the right side and complete on the left and a complete cleft of the hard palate. Primary lip and nose surgery was performed at 9 weeks of age. The subject was 8 months of age at the time of the presurgical MRI scan and 14 months of age at the time of the postsurgical MRI scan. Subject 4 was 9 months of age at the time of primary palatoplasty. The parents reported no history of hearing loss or syndromes. The subject passed his hearing screening at birth. The parents reported no problems with feeding or swallowing.

Preparation of the Participants

Once the subjects' parents agreed to participate in the study, they were required to sign a Health Insurance Portability and Accountability Act (HIPAA) authorization form and consent forms to release data from the clinical MRI scan. The pre surgery scan and data release occurred approximately one month prior to primary palatoplasty for the cleft palate subjects. The subjects with cleft palate were also scanned within six months following surgery as part of a clinical follow-up. The subjects' parents then were asked to sign a second consent form to release the follow-up MRI scan. The parents of the subjects with cleft palate were informed that their presurgical MR images would be used for surgical planning. All parents were informed that their decision to participate in the study will not in any way affect the child's previous treatment plan.

Subject confidentiality was preserved for both written and visual content created as a result of the study. Data confidentiality was maintained by removing identifying information from the released MR images using a DICOM anonymizer program, such as the one contained in Sante DICOM Viewer version 3.4, http://users.forthnet.gr/ath/mkanell/, which replaces the subject name field with blank spaces. Data was transferred to the researcher's computer via secure shell file transfer. The anonymizer removes the subject name field and the data was left with no identifying information. Data was labeled as Subject 1, 2, 3a and 4a (pre surgery), 3b and 4b (post surgery).

General Anesthesia

The subjects received the clinical MRI scans as part of their treatment plan at Carle Foundation Hospital, Urbana, Ill. Therefore, general anesthesia procedures followed the current methods used by the facility and administration and monitoring of patient status was conducted by Carle Hospital personnel. General anesthesia was used on all subjects using a facial mask airway system. This provides a gas and oxygen flow rate of two liters of oxygen per minute. A gas, sevoflurane, was used in a concentration of 2%, which is equivalent to one minimal alveolar concentration (MAC). One MAC is the level at which 50% of people will be anesthetized with no movement. This is necessary to reduce any noise that may occur in the MR images as a result of movement. A pulse oximeter was used to monitor the blood-oxygen concentration levels throughout the MRI scanning session to ensure that levels were kept above 92%. There were no complications due to anesthesia.

Magnetic Resonance Imaging

All MRI was conducted at Carle Foundation Hospital. For subjects with a cleft palate, a 2D high-resolution anatomical scan of the entire head and a 3D high resolution scan of the area of interest (i.e. velopharynx) were acquired. Images for Subject 3 were acquired using a General Electric Echo Speed 1.5 Tesla system (Milwaukee, Wis.) whereas images for Subjects 1, 2, and 4 were acquired using a Siemens 3 Tesla scanner (Trio, Siemens Medical System, Erlangen, Germany). Subject 3 was supposed to be imaged using the 3 Tesla system, however, the scanner did not become available to Carle Foundation Hospital until after the subject's scheduled surgery date. Therefore, both scanning sessions (i.e. pre and postsurgical scan) were completed using the 1.5 Tesla system.

For subjects with cleft palate, 2D high-resolution anatomical scans using proton density weighted imaging were obtained to provide good contrast of the muscle tissue in the axial, sagittal, and oblique coronal imaging planes. T1 weighted contrast was used to obtain 3D high-resolution scans of the oblique coronal plane focusing on the region of the levator muscle. This enabled 3D acquisition with a reasonable scan time. Presurgical MRI images were obtained one month prior to the scheduled surgery date for Subjects 3 and 4. Postsurgical MR images were obtained six and five months after surgery for Subjects 3 and 4, respectively.

Subjects 1 and 2 were each imaged once as part of their clinical diagnosis while at Carle Foundation Hospital. The clinical coronal turbo spin echo scans were taken in the coronal oblique image plane in order to capture the levator muscle. Subjects 1 and 2 served as the control subjects for the study and data obtained from the MR images were used to compare results obtained from subjects with cleft palate (Subjects 3 and 4).

The structures of primary interest during the MRI scans included the velum, hard palate, posterior pharyngeal wall in the sagittal plane, and the levator veli palatini muscle in the oblique coronal plane. The skull and tongue were included in the field of view to assist in the 3D computer reconstruction.

Imaging Protocol and Areas of Interest Subjects with Cleft Palate (Subjects 3 and 4)

Following anesthesia, Subject 3 was scanned using the 1.5 Tesla GE system. Subject 4 was scanned using the 3 Tesla Siemens system. The subjects with cleft palate followed a protocol designed by the researchers which is routinely used for clinical MRIs for individuals with cleft palate when needed. Six total scanning sequences were used to obtain the images. The total scanning time was approximately twenty minutes. The first scan, 3 plane localizer, was acquired in 2D to provide sagittal, axial, and oblique coronal projections of the entire head.

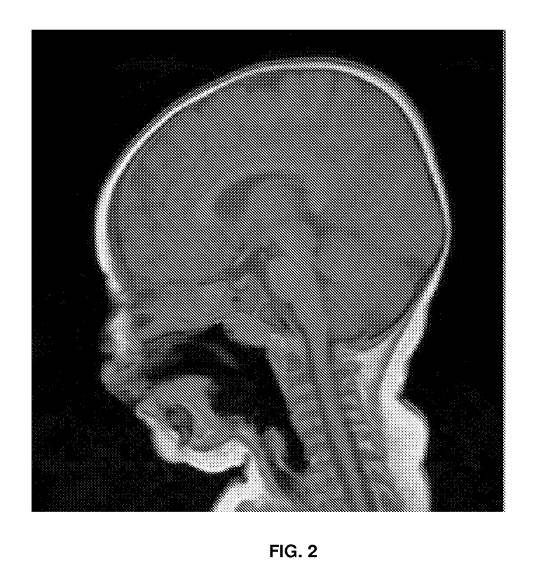

The average time for this scan was 40 seconds. Next, 16 to 17 2D fast spin echo (for 1.5 Tesla system) and turbo spin echo (for 3 Tesla system) sagittal scout images were obtained. This was done to determine the midsagittal plane (FIG. 2). A similar method to that reported by Ettema et al. (2002) was used to determine the midline of the subject. This included identifying the section plane that most clearly depicts the hypophysis, genus of the corpus callosum, and outline of the fourth ventricle.

The sagittal scout images were acquired using the imaging parameters outlined in Table 2. Using the plane determined to be the midline as the scout image, three 2D and one 3D anatomical scan(s) were acquired. A proton density weighted 2D fast spin echo (FSE) sequence were used to obtain 23 to 24 slices along each of the axial, oblique coronal, and sagittal planes. The slice thickness was 1.5 mm with no gap between subsequent slices. The field of view (FOV) was 16 cm with a TE of 17 ms and TR of 3000 ms. Approximately 24 scans along each plane of reference (axial, oblique coronal, and sagittal) were taken lasting 6-9 minutes in total.

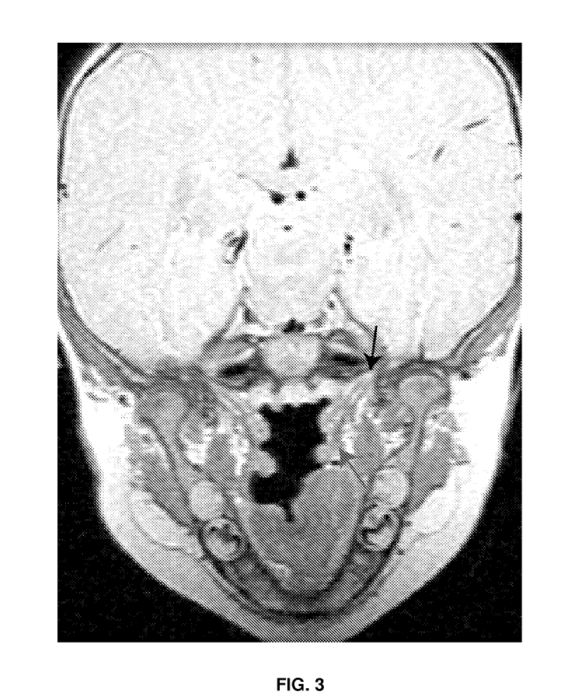

The 2D axial, oblique coronal, and sagittal anatomical scan used the imaging parameters shown in Table 3. The researcher and radiology technologist then determined which oblique coronal section depicts the maximum thickness of the levator sling from its origin to the insertion (FIG. 3). If the muscle was not seen in its entirety, the oblique coronal scan angle was modified and the images were retaken. This was done for two out of the four subjects (Subjects 1 and 3), which doubled the projected time frame for that particular scan (i.e. making it 5 rather than 2½ minutes).

The 3D oblique coronal anatomical scan was used for subjects with cleft palate using the imaging parameters of Table 4.

Subjects without a Cleft Palate (Subjects 1 and 2)

Subjects 1 and 2 were scanned using the 3 Tesla Siemens system. Both subjects were scanned for reasons other than a cleft palate. Therefore, imaging protocols were designed by the chief radiologist and modified by the radiology technologist during the scanning session. The protocol for Subject 1 included a sagittal turbo spin echo (TSE) whole head scan, axial T2 FLAIR, axial T2 3D TSE, and a coronal oblique TSE. The imaging parameters of Tables 5-8 were used for scanning Subject 1. A whole head scan was performed on Subject 2 to assess the reoccurrence of seizures beginning four days prior to the MRI scanning session. A sagittal T1, axial T2, coronal magnitude, coronal 3D MPRAGE, diffuse weighted 2D axial, and a 2D coronal oblique anatomical scan was obtained.

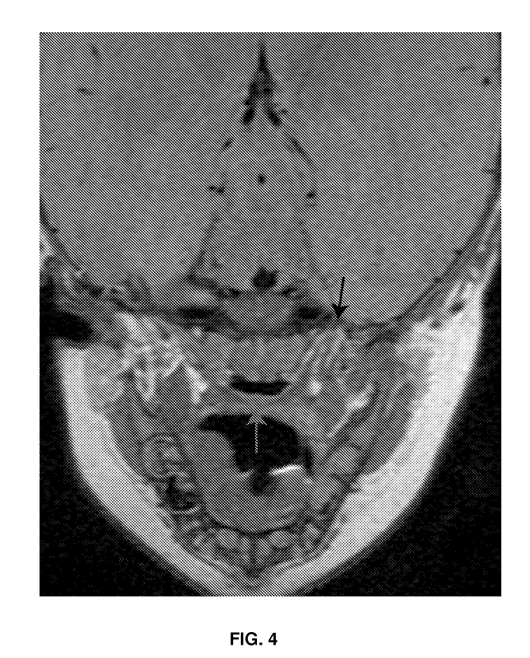

The protocol used for scanning Subject 2 are shown in Tables 9-14. The three plane localizer images were used during the computer reconstruction of the skull. The sagittal scout images were used to assist in computer reconstruction of the midline structures, including the hard palate, velum (i.e. postoperatively), and posterior pharyngeal wall. Sagittal images were also important in constructing the skull, with particular focus on the base of the skull. The anatomical scans provided further detail in the axial, oblique coronal, and sagittal planes through the velopharyngeal mechanism. The oblique coronal image that displayed the levator muscle in its entirety was used to obtain quantitative measures for the subjects without cleft palate and for subjects with cleft palate both before and after primary palatoplasty (FIG. 4).

Surgery

Surgery was performed at Carle Foundation Hospital in Urbana, Ill. by the chief surgeon of the oral and maxillofacial surgical team. Both subjects with cleft palate (Subjects 3 and 4) received a V-Y push-back (Wardill-Kilner) surgical procedure which utilizes two posteriorly based unipedicle flaps. Incisions were made along the lateral margins of the hard and soft palate and along the medial borders of the cleft. The oral mucoperiosteal flaps were raised to expose the neurovascular bundles. Dissection at the posterior edge of the hard palate revealed the underlying levator veli palatini muscle. The neurovascular bundles were dissected from the mucoperiosteal flap to allow for medial rotation of the oral flaps toward the midline. The levator muscle is dissected off the posterior bony edge of the hard palate and from the nasal mucoperiosteum.

The tensor tendon is dissected around the hamulus to allow for relaxation and advancement of the levator sling. Levator fibers were maintained in a cohesive bundle and joined with the opposing levator muscle bundles to form a sling through the body of the velum. The nasal mucosa is dissected from the palatal shelves and is repaired providing a reconstructed nasal floor. In the unilateral cleft lip and palate repair, as in Subject 3, the nasal flaps were rotated toward the midline and sutured along the full length of the hard and soft palate. In the bilateral cleft lip and palate repair, as in Subject 4, a mucoperiosteal flap was created from the vomer and used to create closure with the nasal layer. This allows for a wide cleft to be brought to the midline.

There were no complications during surgery. Both attended their surgery follow-up appointments and were found to be in good health and having no complications as a result of surgery.

Image Analysis and Processing

Once the MR images were obtained, they were sorted using a Dicom Reader (Image Information Systems, United Kingdom). All the images were placed in their corresponding file folder and labeled numerically in the order in which they were taken. This was particularly necessary when using the 1.5 Tesla GE system. The Siemen's system (3 Tesla) arranged data differently usually requiring little to no changes to the file folders. This step was critical in order to process the images using Amira.

Once the images were sorted, each file folder of images (localizer images, sagittal scout images, 3D coronal oblique images, and the 2D anatomical scans in the sagittal, oblique coronal, and axial planes) were brought into Amira (version 4) 3D Visualization and Volume Modeling software (Mercury Computer Systems Inc; Chelmsford, Mass.). Amira 4 for Microsoft Windows was used with the following technical specifications: dual core Xeon 3.0 GHz with 3.0 GB of RAM and an NVidia Quadro FX 1300 graphics card. Amira was used to complete the tasks described below.

Measuring the Levator Veli Palatini Muscle

Using the measuring tools (i.e. straight line tool and angle tool) provided by Amira, the levator muscle dimensions were calculated using a similar method reported by Ettema et al. 2002. Measurements were taken from Subjects 1, 2, and Subjects 3, 4 both before and after primary palatoplasty. All measurements were done using the oblique coronal MR image that displayed the levator muscle in its entirety and from an orthographic view to eliminate any perspective distortions that may occur while using the 3D software program (Amira). The levator bundles in the subjects with an unrepaired cleft palate (Subjects 3a and 4a) were found to have an abnormal course and placement within the velopharynx. As expected, instead of creating a sling through the midline, the levator fibers terminated on the hard palate. As a result, the muscle length and angle of origin measures were taken differently for subjects with an unrepaired cleft palate and those with normal anatomy. The following measurements and methods were used.

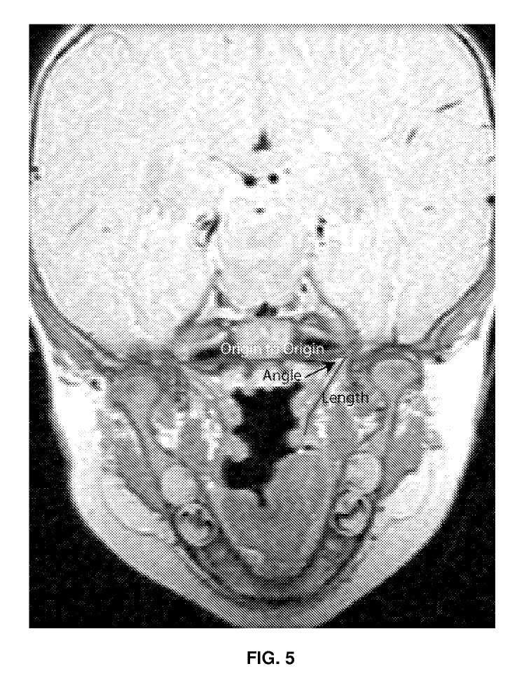

Origin to Origin: The distance between each levator bundles origin at the base of the skull was obtained by placing a reference line from the apex of one levator bundle at the level of the petrous portion of the temporal bone extending to the same point on the opposing levator bundles (FIG. 5). This measure was obtained in the same manner for all subjects.

Muscle Length: The left and right levator bundles length was determined as the distance of the muscle from the origin to the insertion. The levator muscle length was measured by using a vector line descending from the ends of the reference line through the body of the levator muscle (FIG. 5). In subjects with an unrepaired cleft palate (Subjects 3a and 4a) the vector lines followed the path of each levator bundle to terminate at the level determined to be the attachment of the levator bundles onto the hard palate. In subjects without a cleft palate (Subjects 1 and 2) and those with a repaired cleft palate (Subjects 3b and 4b), the vector line traveled from the origins to terminate in the midline of the velum.

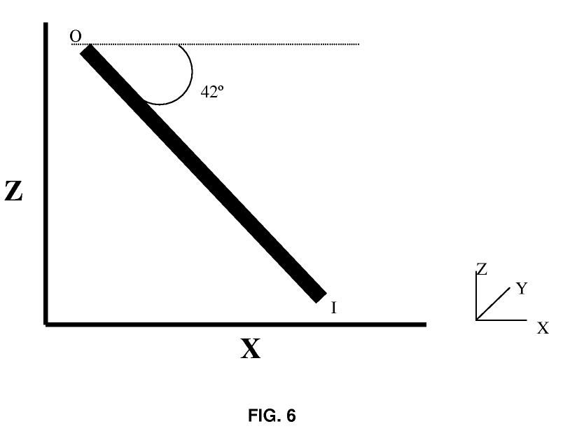

Angles of Origin: There are three major angles of origin to the levator muscle in the following planes: (a) oblique coronal, (b) oblique sagittal, and (c) axial. However, only the oblique coronal and oblique sagittal angles of origin were measured in the present study. The angles of origin in three dimensions can be visualized in a video simulation. A simple schematic can be used to display a person's right levator muscle bundle as a cylinder within a cube to represent the x, y, and z coordinates. A two dimensional representation can be appreciated in FIGS. 6, 9, and 38.

Oblique Coronal Plane

FIG. 6 displays the oblique coronal plane. The dotted line represents the base of the skull, also designated by the “O” or origin of the muscle bundle. The muscle courses away from the origin forming an angle with the base of the skull.

The left and right angles of origin were determined as the angles created by the base of the skull and the descending levator bundles as they course anteriorly, inferiorly, and medially into the body of the velum. In subjects with a repaired cleft palate (Subjects 3b and 4b) and subjects with a normal mechanism (Subjects 1 and 2) the angle of origin measurement of the levator muscle was obtained by using the angle measuring tool to measure the angle created between the reference line and the vector line for each levator bundle (FIG. 5).

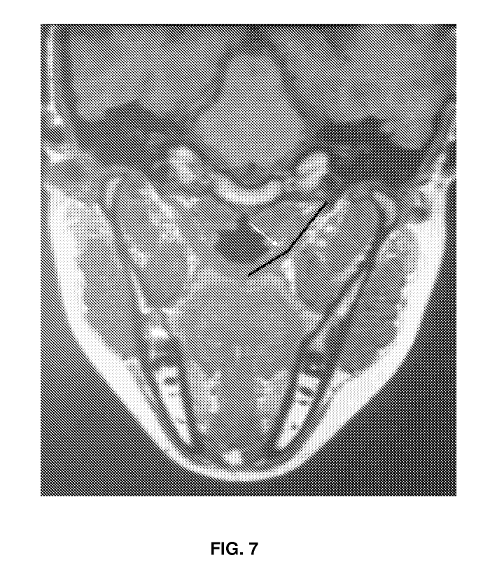

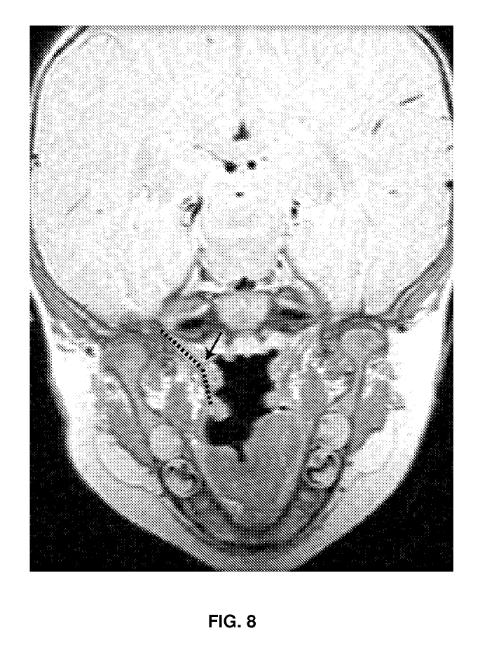

In subjects with an unrepaired cleft palate (Subjects 3a and 4a), the levator muscle coursed from the origins inferiorly, medially, and anteriorly. Approximately half way through its course, the muscle discontinued its primarily medial direction and diverged more anteriorly and inferiorly before inserting onto the hard palate. In individuals with a normal mechanism, the levator fibers follow a similar course, however, as demonstrated by Ettema et al. (2002), the levator fibers form an obtuse angle just before progressing to the midline (FIG. 7). This muscle bend was not observed in Subject 3 before primary palatoplasty. Instead, the muscle turned anteriorly inverting the angle (FIG. 8).

Oblique Sagittal Plane

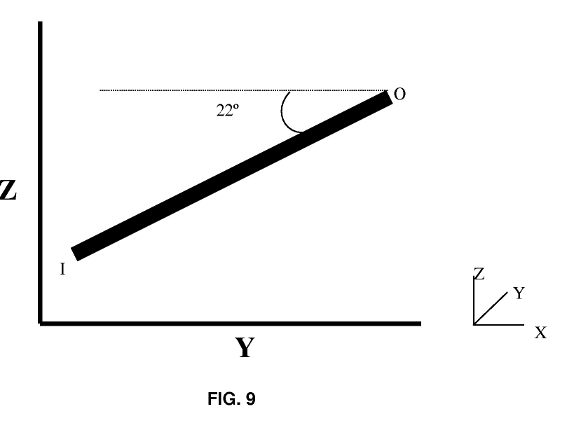

FIG. 9 displays the muscle angle in the oblique sagittal plane. Through visualizing the muscle in the oblique sagittal, the steepness of the muscle can be appreciated. A muscle that is steeper or vertically oriented would display a larger oblique sagittal angle of origin. In contrast a muscle that coursed more anteriorly and horizontally would display a smaller oblique sagittal angle of origin. A steeper muscle would provide greater leverage force in providing upward movement.

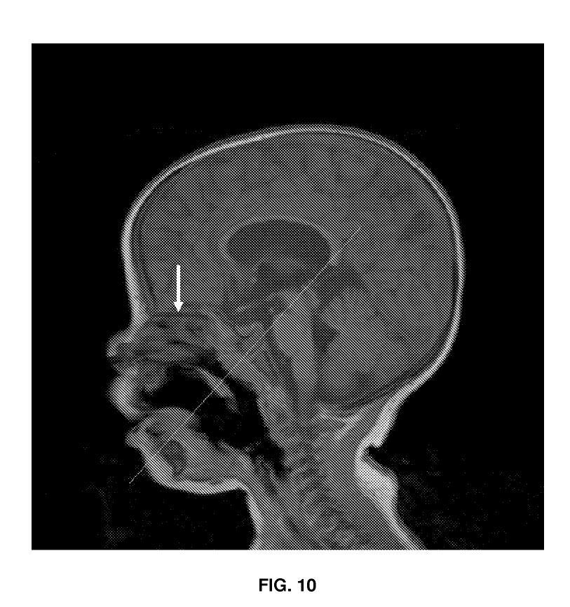

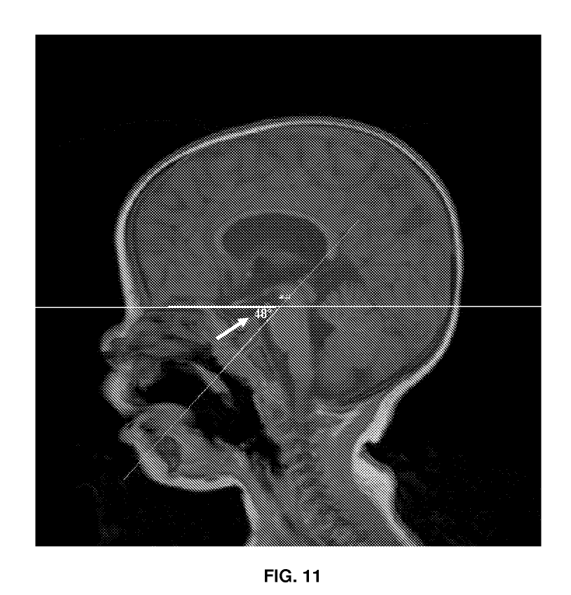

The angle of origin in the sagittal image plane was obtained by using the midsagittal MR image and the oblique coronal MR image that displays the muscle in it entirety (FIG. 10). The two images were overlaid onto each other and a reference line was drawn through the sagittal image. The reference line coursed through the cribriform plate (FIG. 11). This is a midline structure that can be easily seen on the midsagittal plane and is consistent in its direction and orientation between subjects. The angle was then determined as the angle created from the reference line and the oblique coronal image (FIG. 11). A single angle measure was obtained which represents the angle of origin in the oblique sagittal plane for both the right and left levator muscle bundles.

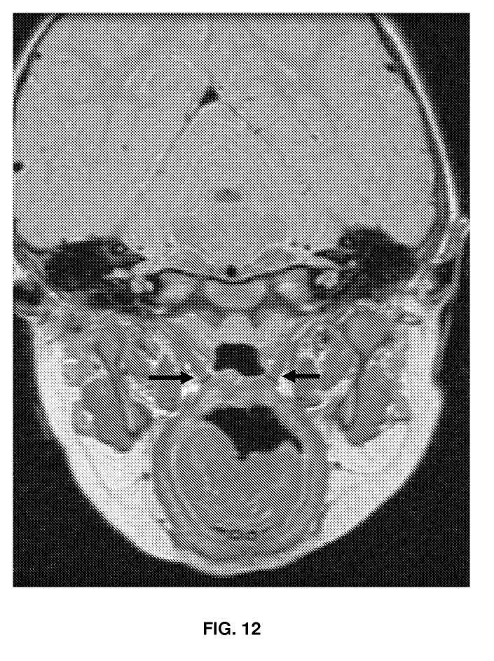

Muscle Thickness: As noted by Ettema et al. (2002), muscle thickness in the midline, particularly in the individual without a cleft palate (Subjects 1 and 2) will likely be larger. This is due to the presence of the musculus uvulae through the midline of the velum, which is difficult to separate from the levator fibers when taking midline thickness measurements. As previously mentioned the musculus uvulae may be absent or reduced in individuals with a repaired and unrepaired cleft palate. Therefore, even after surgical repair of the hard and soft tissue structures, this muscle still may not contribute to midline thickness measurements. In addition, following palatal repair, the levator muscle may not be a cohesive muscle mass in the midline making it difficult to determine the true thickness of the muscle in that location. For these reasons, the thickness measurements were taken at the region where the muscle turned medially just before heading into the body of the velum (FIG. 12).

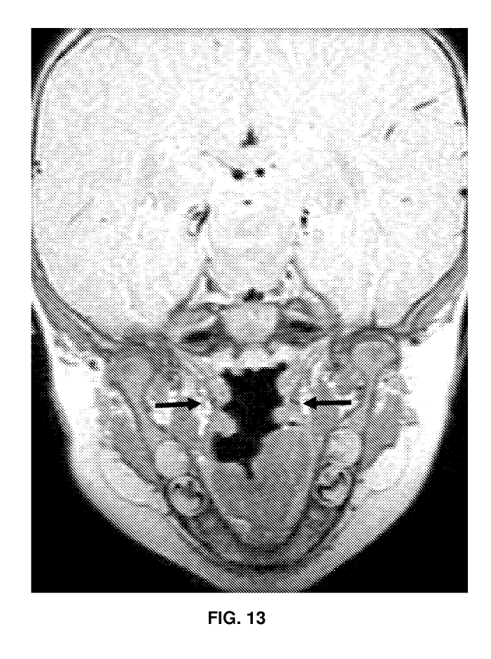

In subjects with an unrepaired cleft palate (Subject 3a and 4a) the thickness of the levator sling was determined by measuring the muscle thickness at the similar muscle location as in the subjects without cleft palate (FIG. 13).

The numerical values obtained from the oblique coronal image processing were analyzed using Microsoft Excel for Windows 95, Version 7.0 (Microsoft, Redmound, Wash.).

Reliability Measures

Segmentation and measurements were done manually using the tools provided in Amira. The researcher viewed all the oblique coronal images to determine which image displayed the muscle in its entirety. The muscle was identified from the surrounding tissue based on what is expected for the muscle course and configuration. The levator muscle can be delineated from surrounding muscles due to its uniform muscle direction in that it is the only muscle that courses inferiorly and medially (from the oblique coronal image view) in the area of the oral and nasal cavities. It was important to conduct reliability measures to ensure the data could be accurately identified and data extraction could be duplicated both within and across raters.

Two raters independently measured the levator muscle dimensions across all subjects. The first rater was the researcher who has training and experience in viewing MR images and studying the levator muscle in individuals with a normal mechanism and individuals with a cleft palate. The second rater was an undergraduate student in the Department of Speech and Hearing Science. Before viewing the MR images, the researcher trained the student using MR images published in previous research articles (Kuehn et al., 2004; Ettema, et al., 2002). Training consisted of two meetings of approximately two hours each.

The MR images for all subjects were randomly arranged and used to measure the levator muscle. Raters measured the levator dimensions independently of each other. Three measurements for each dimension were taken for each subject by both raters. The measurements were spaced seven to ten days apart. Tables 21-24 displays the levator muscle measures taken across three separate occasions and between two raters. The measurements were very similar within and between raters. For the origin to origin measurements, 92% agreement for the primary rater was reached within 0.15 cm difference and 89% agreement was reached between raters within 0.15 cm. For the length measurements, 90% agreement was reached within 0.26 cm difference for the primary rater and 100% agreement between raters within a 0.26 cm difference.

Ninety percent agreement was found within 5 degrees for the primary rater and 84% agreement was found within 6 degrees between raters. For the thickness measurements 92% agreement was found within 0.06 cm difference for the primary rater and 97% agreement was found within 0.05 cm between raters. Overall, all measures proved to show good reliability within and between raters. The angle of origin measurements (in oblique coronal plane only) showed less agreement both within and between raters compared to the other measurements. This measure was a very sensitive measure as any change in the reference lines or origin location yielded somewhat different measurements. For example, it was critical that the reference line coursed between origins and a second through the center of the levator muscle. If the line did not course directly through the middle of the muscle bundle, it caused a shift in the angle measurement obtained.

Measuring the Velopharyngeal Port

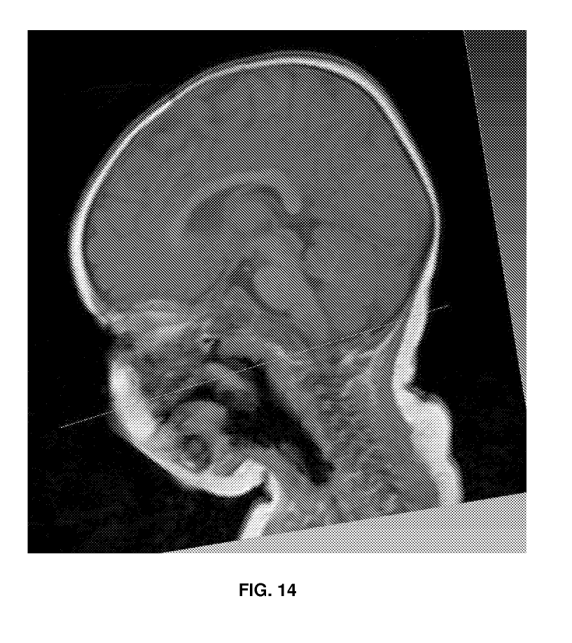

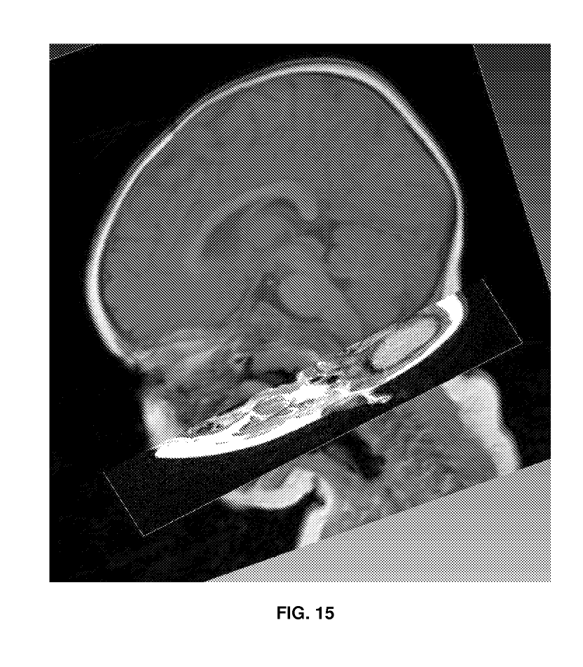

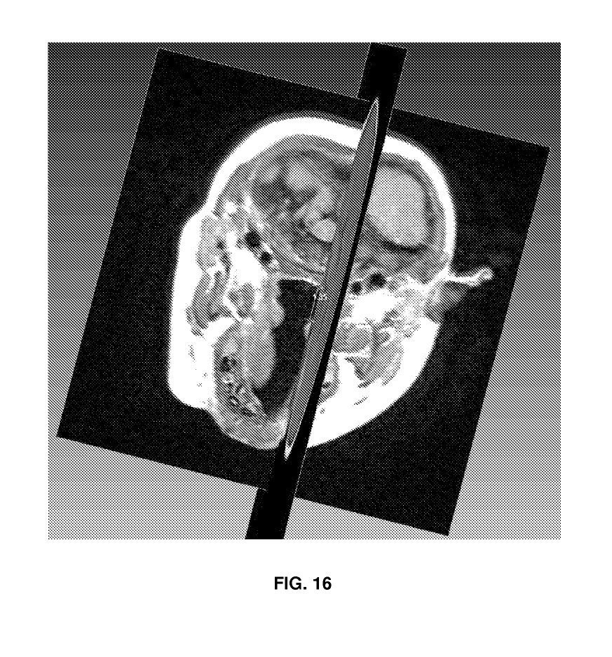

The anterior-posterior dimension of the velopharyngeal port is especially important in velopharyngeal closure. Using Amira, the sagittal and axial MR images were used to measure the distance from the knee of the velum to the posterior pharyngeal wall in all subjects. For subjects with a cleft palate, the anterior to posterior velopharyngeal port measure was obtained before and after surgery. Using the sagittal image set, the body of the velum was identified. In subjects without a cleft palate and subjects with a repaired cleft palate, the midsagittal image displayed the central body of the velum. In subjects with an unrepaired cleft palate, a more lateral sagittal image was used in order to visualize one half of the velum. Once the sagittal reference image was obtained (FIG. 14), the axial images were overlaid onto the sagittal reference image (FIG. 15). The axial image that displayed the hard palate was used to obtain the anterior to posterior velopharyngeal measures (FIG. 16). In subjects with an unrepaired cleft palate, the anterior to posterior measure was obtained from both the right and left halves of the velum.

Data Segmentation and Extraction

Data segmentation was performed using Amira segmentation tools. Image processing, selection, and classification of 3D voxels were conducted on the oblique coronal, axial, and sagittal image sets in order to obtain the anatomy of interest for the 3D computer model. The tools provided in Amira (Table 15) were used to highlight and select the region of interest. The magic wand, blow tool, or active contours were used to select the general area of interest including the skull, hard palate, velum, oral mucosa, and tongue. Table 15 provides a detailed description of the Amira tool options.

Corrections were made using the paint brush and lasso tool for each slice. An Intuos 12×12 Tablet with serial connector (Wacom Direct, Vancouver, Wash.) was used to improve the accuracy of the segmentation. The Intuos Tablet uses a digital pen and tablet rather than a mouse to identify and select the boundaries of the anatomy structures. This ensured a precise segmentation of the areas that were extracted. Each segmented structure was given a separate material (designated by different colors) in order to export each structure individually rather than as an entire data set.

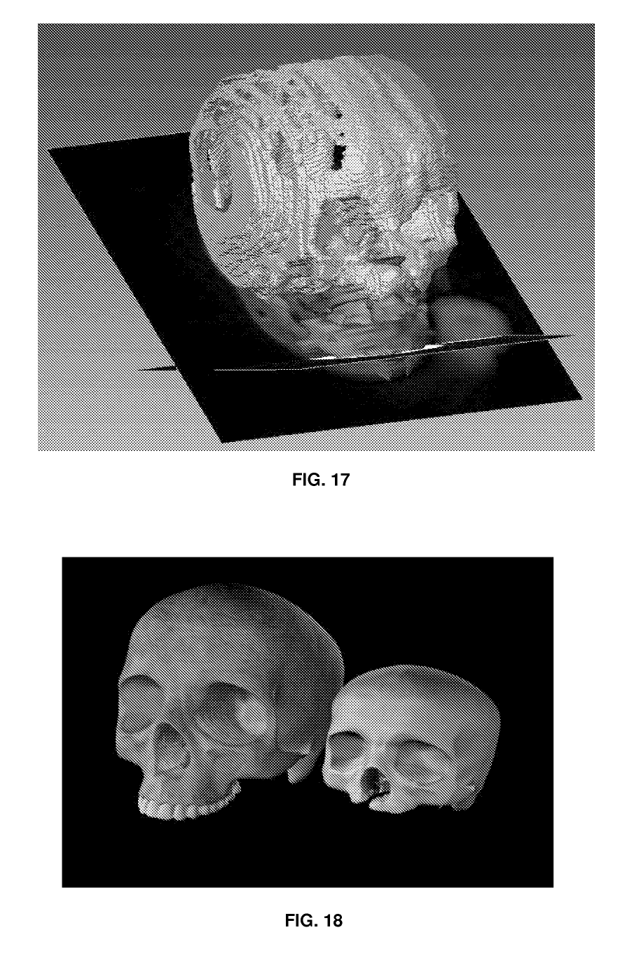

The successive oblique coronal images that represent the muscle in its entirety were used to segment the levator muscle fibers. Voxels of the combined slices were used to create a voxel set. The levator bundle fibers were segmented by hand using the paintbrush, wand, and lasso tool. The axial image sets were used for segmentation of the mandible, oral cavity, and pharynx. Hand segmentation of the skull, nasal cavity, hard palate, velum, and posterior pharyngeal wall was performed using the sagittal images. Once the muscle and structures were segmented, label fields were used to stack each successive image and separate each data set. Once the area was selected (e.g. levator muscle) and labeled, a surface generation (polygonal map) was created which could be displayed with other anatomy (e.g. skull or mandible) or as an isolated structure (FIG. 17).

Amira uses several smoothing techniques, however, this can lead to a loss of data particularly when the object has relatively few voxels selected as in the case of the levator muscle. Using unconstrained smoothing, a program default, will yield a smooth muscle that consists of less than a quarter of the segmented size. For this study, the default was changed to no smoothing in order to ensure that no data points would be lost during the surface generation. The surface generations were saved as an .obj file (Alias-Wavefront) and exported as individual muscles and structures.

3D Computer Modeling

The exported .obj files were then imported into Maya 7.0 (Autodesk, Ontario, Canada) software system where the sectioned regions were combined to create a computer model in three dimensions of space. The imported files create surfaces that are composed of polygonal meshes. The surfaces are outlines of the voxels from Amira that were segmented. As a result, the surfaces tend to be rigid and irregular, lacking realism (FIG. 17). Maya was used to create anatomical models using the measurements obtained from Amira and following the contours of the imported surfaces. The resulting models were designed to be an accurate and realistic representation of the velopharyngeal mechanism. Three general steps were designed and used for creating anatomical models for all subjects. The followings steps included creating the internal anatomy, surgical simulations, and postsurgical anatomy.

Creating the Internal Anatomy

A gray-scale adult skull polygonal mesh was obtained from Software for Integrated Musculoskeletal Modeling (Musculographics, Santa Fe, Calif.). Vertices and faces of the Maya skull model were moved and scaled to change the anatomy to match that of the exported Amira skull segmented models (FIG. 18). Illustrations of infant skulls in textbooks were used to guide the modifications. The shape geometry tools in Maya were used to ensure that the hard palate and petrous portion of the temporal bone were matched to the original data obtained from MRI and Amira segmentations.

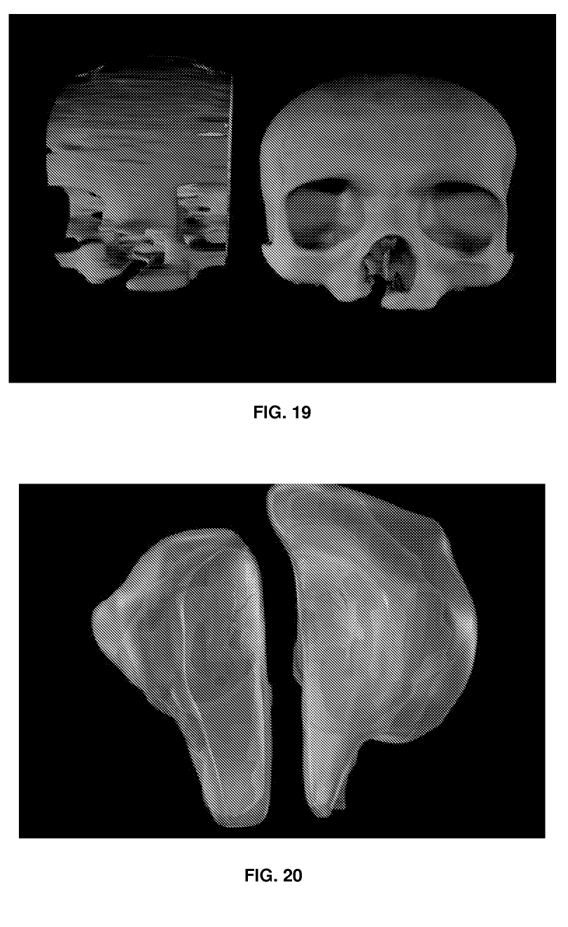

Using the imported Amira skull model, a polygonal cylinder was created and shaped to fit the cleft in the hard palate. The lateral margins of the cylinder were bounded by the medial edges of the hard palate. As a result, the cylinder shape was defined to be the cleft or gap between the palatal shelves. The cylinder was then overlaid onto the smooth Maya model and a boollean union and difference was used to create the same cleft from the Amira model onto the Maya model (FIG. 19). The end product was a skull with a cleft palate that fit the contours of the original segmented Amira data. By using a model to re-create the Amira segmented model, a smooth and realistic model could be created with details that were not present on the Amira model. For example, the styloid process, pterygoid plates, and hamulus are not easily detected on the original MR images. As a result, when segmented through Amira, they are not included in the 3D model. By creating a model through modifications of a skull to fit the data, the fine details of the skull could be included (FIG. 19).

Once the bony framework was created, the soft tissue structures were created and overlaid onto the skull. The mucosa, velum, pharynx, and levator muscle were segmented using Amira and imported into Maya. Methods for creating a smooth polygonal model were similar to the method for creating the skull. The Maya model was constructed using polygonal shapes (cylinders and cubes) to create a volume that matched the contours of the Amira segmented models (FIG. 20). All structures were created as subdivisional surfaces and before creating the animation were converted into polygons. This allows for smooth and realistic textures to be applied.

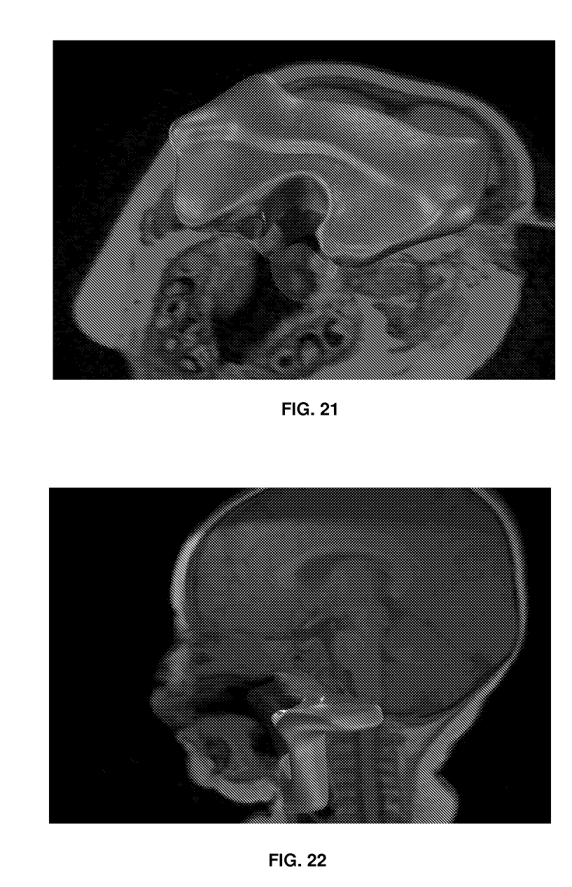

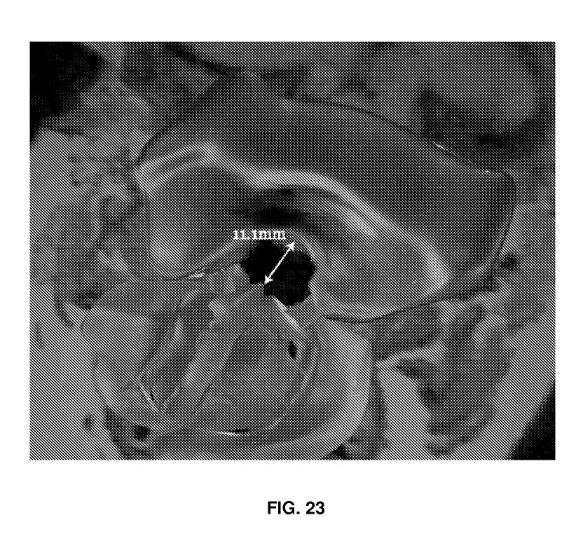

The pharynx was segmented in Amira using sagittal and axial image sets. The posterior pharyngeal wall was outlined in the sagittal images and the axial images served as a guide for the lateral pharyngeal wall boundaries (FIGS. 21 and 22). The axial image that coursed directly through the main mass of the hard palate was used to determine the distance between the velum and the posterior pharyngeal wall (FIG. 23). In the Maya model, the pharynx was extended inferiorly beyond the boundary determined through the MR images. As a result, some of the modeling of the pharynx, specifically the lower pharynx was created subjectively. However, this region does not have major implications on the structures and functions of the velopharyngeal mechanism.

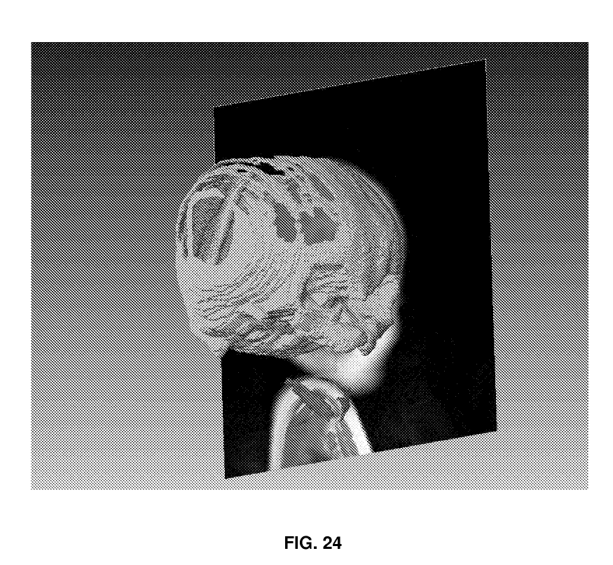

All sagittal data were imported into Maya as it existed in the Amira program. However, the coronal oblique data, specifically the levator muscle, when segmented and created into a surface generation in Amira, would be out of place relative to the other anatomy (FIG. 24). This was also observed when the segmented surfaces were imported into Maya. This problem was not resolved and appears to be a result of the MR image acquisition rather than a result of conversion between Amira and Maya since the problem was observed in both programs. Therefore, it was necessary to translate the muscle into the appropriate location once in Maya.

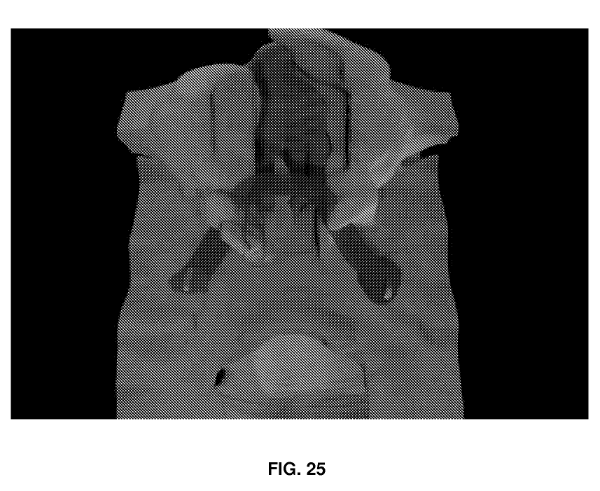

In order to ensure proper placement of the muscle relative to the surrounding anatomy, reference markers were created through Amira to mark the location of the origin of the muscle (FIG. 25). Since the muscle inserted onto the hard palate preoperatively in both subjects with cleft palate, the insertion point was marked by the most posterior edge of the hard palate. The reference points in Amira were created by making a new material that created a circle directly at the junction between the base of the skull and the muscle origin. The reference markers were attached to the skull. As a result, when the skull was imported into Maya, the reference markers were visibly present on the Amira model.

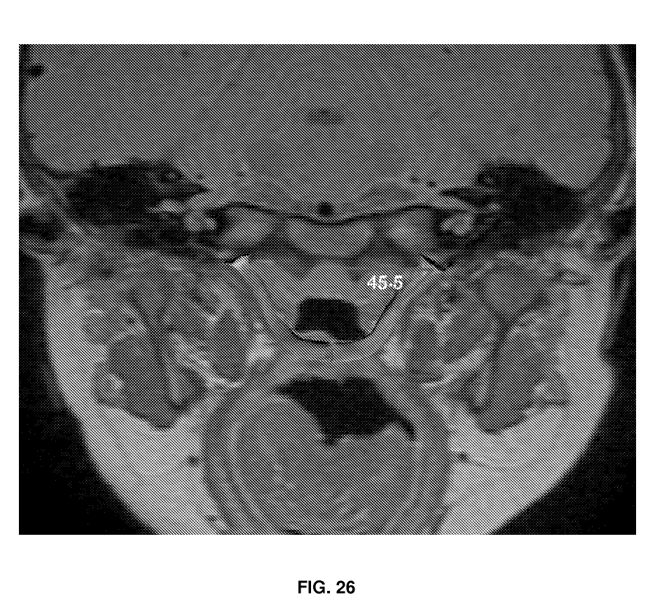

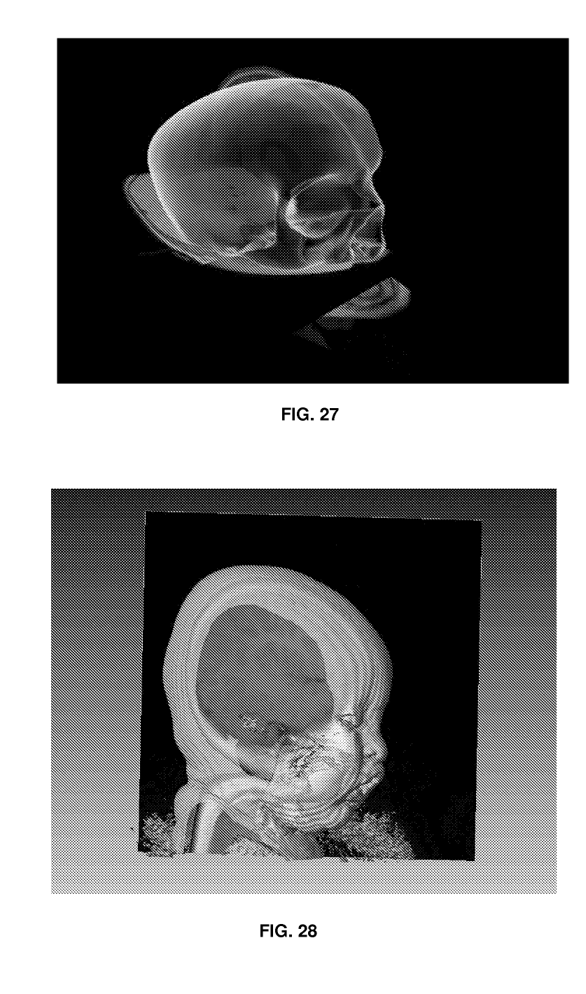

Measurement tools in Maya were used to confirm that the new constructed models matched the measures taken from the original MRI data. For example, an angle tool was used in Maya to verify that the levator muscle was positioned in the Maya model with the appropriate steepness as it diverged from the base of the skull towards the hard palate or body of the velum (FIG. 26). The anatomical sagittal, oblique coronal, and axial MR images were imported into the Maya scene and overlaid onto the model. This provided further detail (e.g. size, shape, and position) of the velopharyngeal anatomy in all directions (FIG. 27). Isosurfaces were created in Amira to provide further detail of the general shape and contours of the skull and face (FIG. 28). The final reconstructions were reviewed by two individuals who have experience with the anatomy of the velopharyngeal mechanism. Modifications were made as necessary.

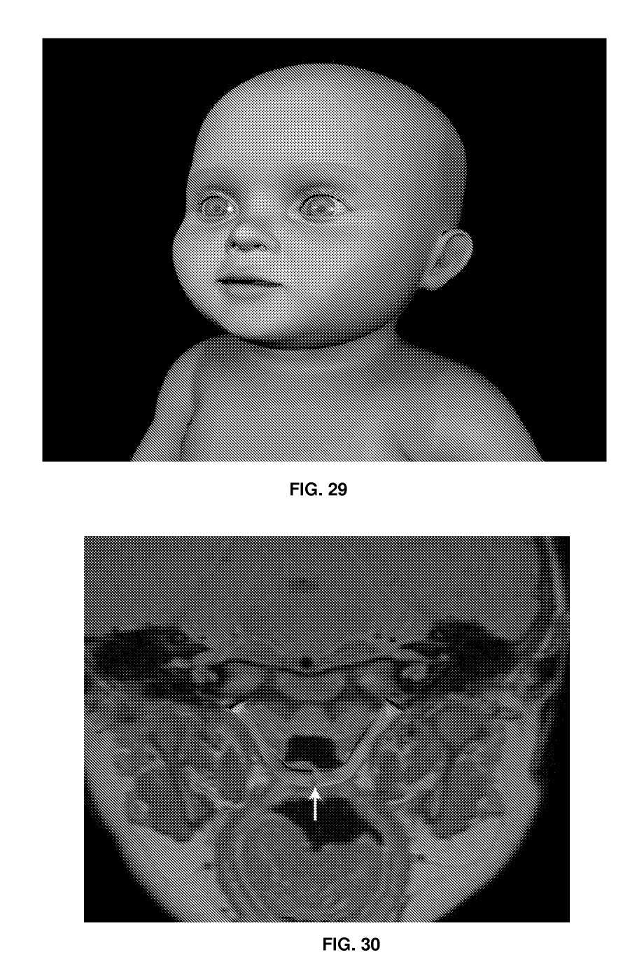

Lastly, an interactive 3D figure design software, Poser 6.0 (Scotts Valley, CA) provided the infant skin polygonal mesh which was overlaid onto the skull model. The photorealistic textures from Poser 6 were used to create realism to the 3D computer face model (FIG. 29). Textures for the skull and internal structures (e.g. muscles, velum and mucosa) were created using Photoshop CS2 (Adobe Systems Incorporated, San Jose, Calif.). Photographs of dissections served as the source images for creating photorealistic muscle, soft tissue, and hard tissue textures. The image files were imported into Maya and used in combination with bump maps to give a perception of texture and depth to the structures. Multiple lights of varying colors including yellow, red, and blue were added to the final Maya scene to add realism and increased perception of depth.

The methods used to create the models of internal anatomy for subjects with cleft palate and those without were similar with two notable differences. First, the creation of a cleft was only applied to the models of Subjects 3 and 4. Secondly, because subjects without a cleft palate had an insertion of the levator muscle into the body of the velum, the insertion marker was slightly different. A marker was placed at the origin of the muscle at the base of the skull. The insertion reference marker was determined by overlaying an MRI into the actual model and visually placing the muscle onto the MR image matching the lateral boundaries with those in the image (FIG. 30).

Creating Surgical Simulations

The subjects with cleft palate were patients receiving surgery and treatment at Carle Foundation Hospital and through the Cleft Palate Clinic (Urbana, Ill.). The models created from the presurgical MRI data, were used to conduct presurgical planning with the guidance of an oral maxillofacial surgeon. Three to four weeks prior to the surgery, the surgeon and researcher used the computer model to interactively manipulate the levator muscle, nasal mucosa layer, oral mucosa layer, and velum. The model was rotated and viewed from numerous angles. The overlying anatomy was removed and/or made transparent in order to gain a view of the underlying anatomy as it exists. Once the levator muscle and soft tissue structures were correctly relocated by the surgeon, the movements were key framed for animation.

The surgical planning for subjects with cleft palate included the following: incisions lines, dissection of the oral mucoperiosteal, rotation of neurovascular bundles, dissection of the levator muscle off the hard palate, amount of levator muscle retropositioning, creation of mucoperiosteal flaps from the vomer (for bilateral repair only), and suturing of the nasal and oral mucoperiosteal flaps to reform the hard and soft palate. Maya measuring tools (i.e. straight line and arch tools) were used to quantify the movements suggested by the surgeon. Measurements included the amount of medial and posterior displacement of each levator bundle and the levator muscle length changes. The surgical planning movements were used to create a short animation of the proposed surgical plan.

Adobe After Effects 6.5 (Adobe Systems Incorporated, San Jose, Calif.) was used to convert the animations into movie files and to add measurements. Composition settings used for each file included: NTSC 720 by 648, 30 frames per second, and interpreted footage as premultiplied with matted color. Text files were used to illustrate the measurements. The After Effects pen tool was used to render the stroke of a line that traveled through the belly of the levator muscle. The rendered stroke was keyframed to show the course of the muscle from the origin to the insertion. This method was used for pre and postsurgical measurements. Narratives were included in the movies to describe the sequences used for each surgery. The narrative files were imported as .wav files into Adobe After Effects and added to the compositions. The final animation was burned to a DVD and given to the surgeon one week before the scheduled surgery date. The animation was viewed by the surgical team prior to the scheduled surgery for both subjects with cleft palate.

Creating Postsurgical Anatomy and Animations

Subjects 3 and 4 were imaged a second time at six and five months (respectively) following surgery. Magnetic resonance images were processed in Amira and Maya using the previously described methods. The creation of a postsurgical model allowed for comparisons to the pre surgery position and to the measures obtained postsurgically. Comparisons between subjects with cleft palate were also conducted to assess the differences in muscle position following surgery in a unilateral versus bilateral cleft lip and palate.

The techniques described by the present disclosure provided a means to obtain detailed anatomic information before and after primary palatoplasty on the levator veli palatini muscle in infants born with cleft palate using magnetic resonance images (MRI). Three dimensional computer models were created based on the MRI data to demonstrate the pre and postsurgical status. The present disclosure demonstrates the feasibility of using computer technology combined with MRI for the purposes of presurgical planning for cleft palate repair.

Oblique Coronal Images

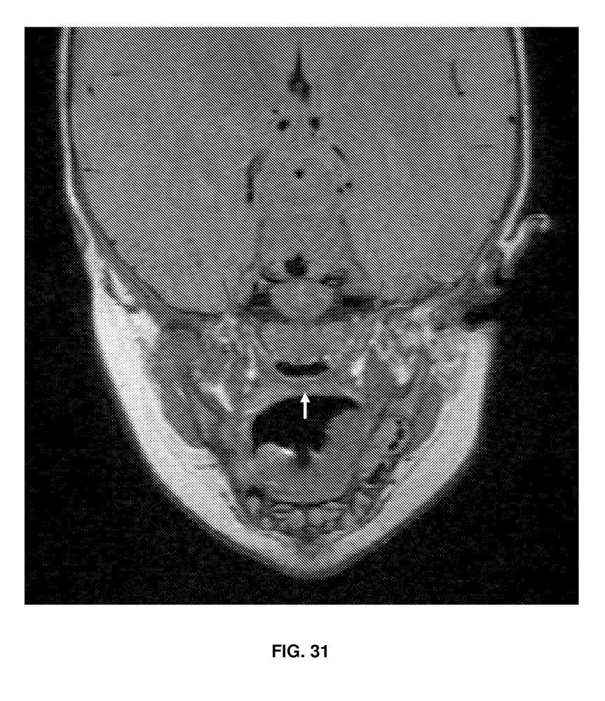

FIGS. 31-36 illustrate oblique coronal images taken for subjects with a cleft palate before and after primary palatoplasty and for subjects without a cleft palate. The red arrows demonstrate the origins of each levator bundle at the base of the skull and the white arrows point to the insertion of the muscle bundles.

Subject 1. Subject 1, a 9-month-old female served as a control for comparisons to the subjects with cleft palate. The oblique coronal image obtained from Subject 1 demonstrates a normal levator sling arrangement. The muscle originates at the base of the skull and forms a cohesive sling through the midline of the velum where the two muscle bundles join. The muscle was visible in four sequential MR images with FIG. 31 representing the MR image that displays the muscle in its entirety. The marked depression on the right side of the subject's tongue is attributable to a breathing tube which was maintained in that position during the imaging session. A similar depression can be seen in all similar figures to follow for all of the subjects.

The breathing tube was necessary as the subjects were anesthetized but it did not appear to have an affect on positioning of the velum or the levator muscle. The subject's head was slightly rotated as evident in FIG. 31. The subject's left ear is partially visible however, the right ear is not visible. In addition, the ventricles of the brain and the mandible are asymmetrical. This explains why the subject's right levator muscle origin is not as visible as on the left. The adjacent MR images were used to verify the correct placement of the muscle origin. The opposing levator origin also served as a reference in guiding the placement of the reference line connecting the two origins. The muscle formed a curved angle just before diverging into the body of the velum.

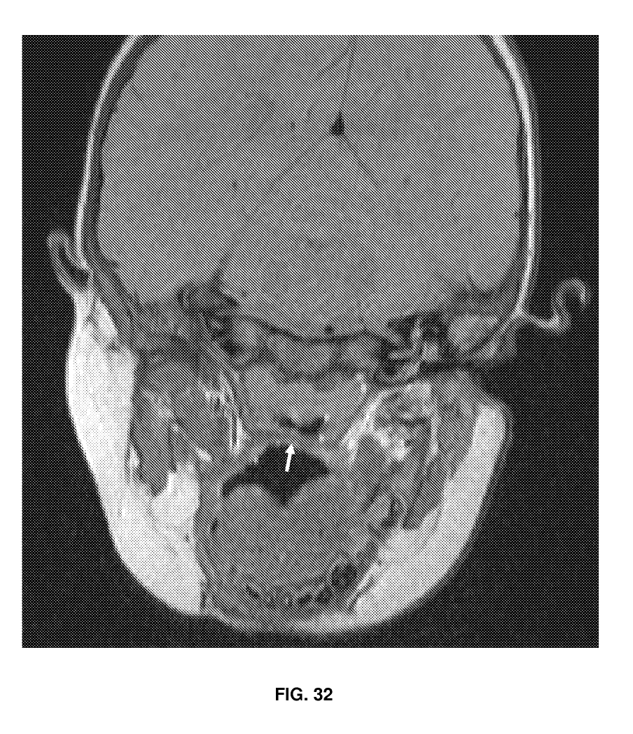

Subject 2. Subject 2, a 10-month-old female served as a control for comparisons to the subjects with cleft palate. The oblique coronal image obtained from Subject 2 also displays a normal levator sling arrangement (FIG. 32). The muscle bend, or angle of the muscle as it turns medially towards the insertion in the velum, formed a sharper angle compared to the curved angle observed in Subject 1. The oblique coronal image from Subject 2 displayed asymmetry which suggests the head was slightly rotated. As a result, the left and right levator muscle origins were not identifiable on the same image. Adjacent MR images were used to identify the origin of the subject's left levator muscle. The opposing muscle place of origin also served as a guide in deciding the location of the left levator muscle origin. The muscle was visible in four sequential MR images.

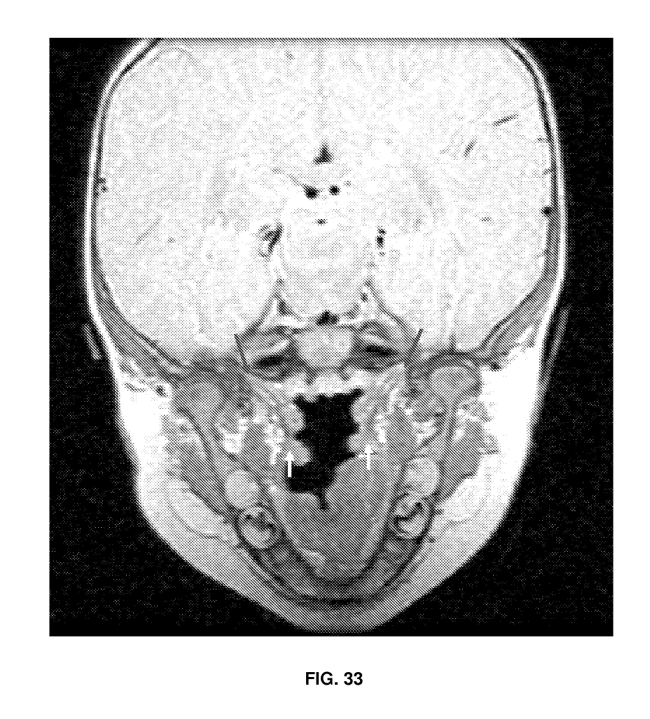

Subject 3. Subject 3 had a unilateral cleft lip and palate and was imaged before and after surgery. FIG. 33, displays the presurgical MRI oblique coronal image. The origin of the levator muscle bundles was clearly delineated from the surrounding structures. The muscle originated at the base of the skull and diverged inferiorly, medially, and anteriorly. At the level of the muscle bend, the muscle discontinued its course medially and continued anteriorly and inferiorly to insert onto the hard palate. As a result, the muscle bend was inverted compared to that of the subjects without a cleft palate. The insertion point for the levator muscle onto the hard palate was not as distinct as the origin points.

Using contrast controls on the Amira program, the gray scale values were modified to increase the contrast between the levator muscle fibers and the surrounding structures. The wand tool in Amira was also used by first selecting the center of the muscle fiber and setting the tool to select voxels with a similar gray scale value in the region of the muscle insertion. This selection method was used to assist in selecting the insertion point of the muscle as it terminated its course at the region of the hard palate. The muscle was visible in four sequential MR images.

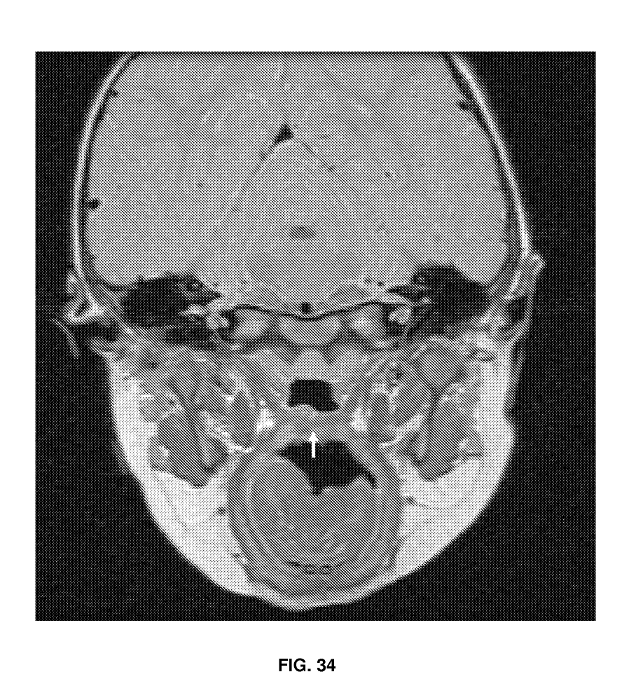

FIG. 34 displays the oblique coronal image of Subject 3 postsurgically. The muscle origin at the base of the skull and insertion of the muscle in the midline of the velum was clearly delineated from surrounding structures. The reconstructed levator muscle coursed though the midline of the velum and where opposing levator bundles were joined. The muscle's angles of origin following surgery were observed to be similar to that of subjects without a cleft palate (Subjects 1 and 2). Overall, the muscular sling appeared to be cohesive in form as it diverged from the base of the skull and inserted into the midline of the velum. The levator fibers appeared to be fully dissected off the hard palate on each side and joined with the opposing muscle bundles. The muscle morphology was observed to be similar to that found in the control subjects (Subjects 1 and 2). The muscle sling was visible in four sequential images.

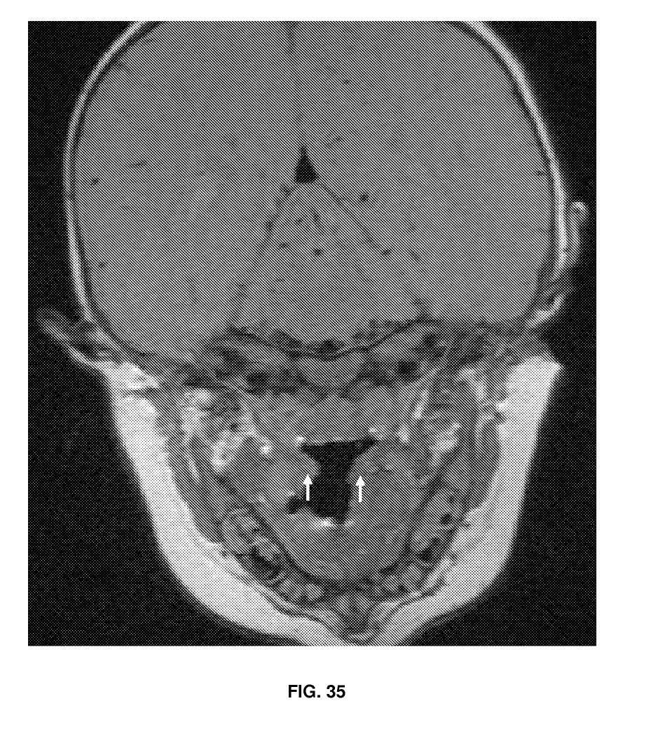

Subject 4. Subject 4 exhibited a bilateral cleft lip and palate and was imaged before and after primary palatoplasty. FIG. 35 displays the presurgical oblique coronal image. The origin of the muscle was clearly delineated from the surrounding structures, however, the insertion of the muscle onto the hard palate was less distinct. The course of the levator muscle presurgically appears to be different compared to Subject 3a. In Subject 3a, at the level of the muscle bend, the muscle diverged anteriorly showing little muscle convergence towards the midline. The levator muscle in Subject 4a coursed inferiorly, anteriorly, and medially from the base of the skull to insert onto the hard palate. The muscle continued to converge towards the midline before inserting onto the hard palate. The muscle bend was greater compared to that observed in the control subjects. The presurgical levator muscle morphology can be simulated and demonstrated in animation.

Similar methods as those used for Subject 3 presurgically were used for selecting the insertion point of the levator muscle in Subject 4. The subject's head was slightly tilted, however the entire muscle was visible in a single image (FIG. 35). The muscle was visible in three sequential images. Before surgery, the levator muscle appears to have a muscle origin angle somewhat smaller compared to the muscle origin angles observed in the control subjects. The muscle appears to be very broad-based from the origin to the opposing origin compared to Subjects 1, 2, and 3. The length of the muscle appears to be longer than that for Subjects 1, 2, and 3 (see next section for measurements).

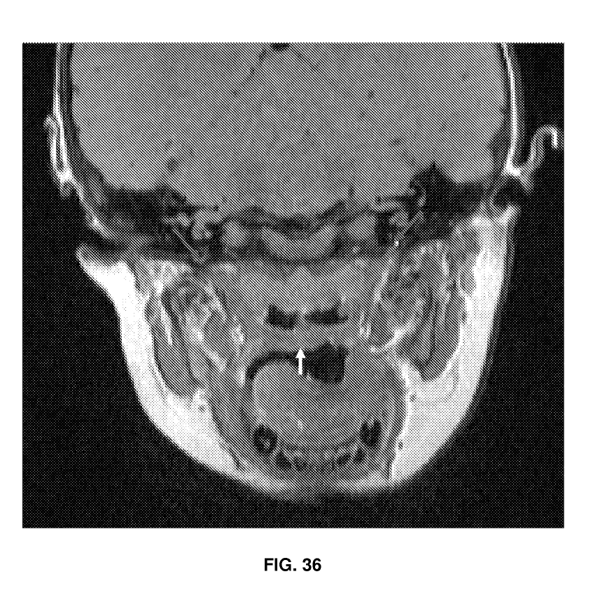

FIG. 36, displays the postsurgical oblique coronal image of the levator muscle in Subject 4. The levator muscle originated at the base of the skull and followed a similar contour as the control subjects (Subjects 1 and 2). The left levator muscle origin was clearly delineated from the surrounding structures. The right levator muscle origin was less distinct. Adjacent MR images were used to guide the placement of the reference line which coursed between both levator origins. Postsurgically, the muscle appeared to be very cohesive and relatively thick compared to the presurgical status, particularly in the inferior half of the muscle. The muscle contour and morphology (length and thickness) appeared to be consistent with the control subjects (Subjects 1 and 2). The muscle was visible in three sequential images.

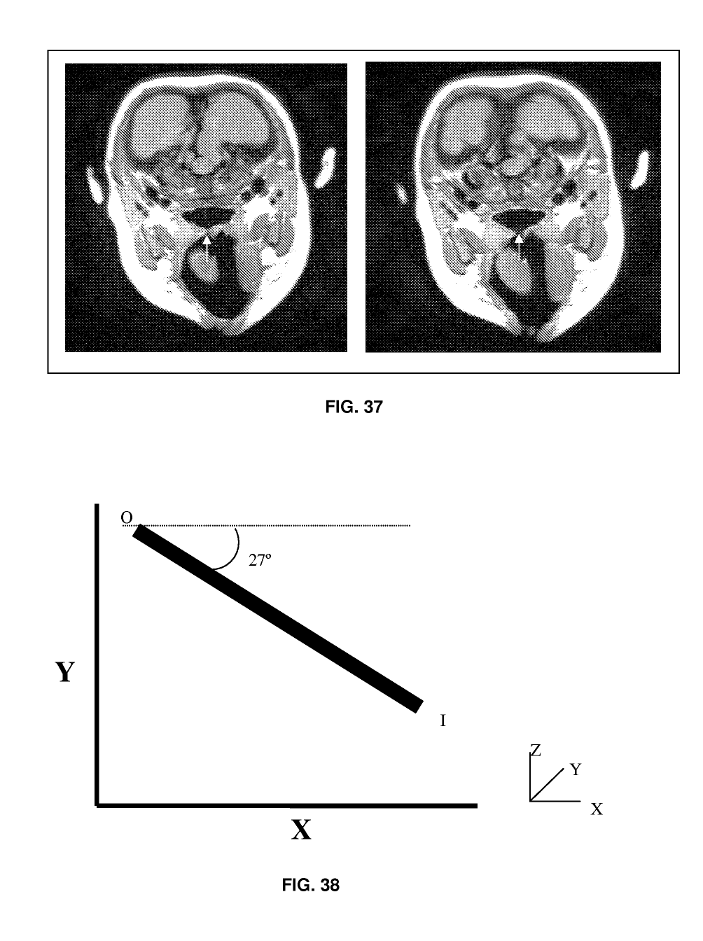

From the axial MR images, it appeared that the uvula had dehisced following surgery (FIG. 37). An oral examination was attempted following the MRI to confirm this observation while the child was still under general anesthesia. However, before this could be done, the general anesthesia wore off and the child was not compliant. One month following the MRI, the subject was seen by his primary physician and a speech language pathologist for enlarged adenoid and tonsillar tissue. During this evaluation, an oral examination was performed and the uvula did not appear to be dehisced. Rather, the uvula appeared to be irregular in form particularly on the patient's left side. It is assumed that this is the cause of the observation seen on the MRI. This observation appears to have no clinical implications in the area of speech development.

Quantitative Measures of the Levator Veli Palatini Muscle

Quantitative measurements of the levator muscle for all subjects are presented in Tables 16 and 17. A computer model and animation can be created to display the levator measurements in three dimensions. Measurements of the levator muscle and the velopharyngeal port opening were obtained using Amira software system using the measuring tools provided by the program. The levator measurements were obtained using the oblique coronal images (FIGS. 31-36) and included the distance between origins, muscle length, angle of the origin, and muscle thickness. The anterior to posterior dimension of the velopharyngeal port was obtained using the sagittal and axial images. Table 16 displays the levator measurements for subjects without a cleft palate (Subjects 1 and 2). Table 17 displays the levator muscle measurements for subjects with a cleft palate (Subjects 3 and 4) before (a) and after (b) primary palatoplasty.

Normal Anatomy (Subjects 1 and 2)

Quantitative measures of the levator muscle for Subjects 1 and 2 are presented in Table 16. Subject 1 (9-months-old) weighed 8.15 lbs and Subject 2 (10-months-old) weighed 22 lbs at the time of the MRI study. Subject 1 displayed a smaller distance between levator muscle origins and shorter levator muscles compared to Subject 2. All of the angles of origins were somewhat similar between both subjects demonstrating a similar steepness and convergence of the muscle as it ascended from the base of the skull to insert into the velum.

Subject 2 showed levator muscle thickness measures that were thicker on the right side compared to that on the left side. Muscle thickness measures between Subjects 1 and 2 were comparable. Overall, there appeared to be variability in the dimensions of the levator muscle for both subjects with normal anatomy, particularly in the distance between origins and the muscle lengths. Subject 2 weighed over twice as much as Subject 1, which might account for some of the differences found in the reported levator muscle dimensions. In contrast, there was little variability in the muscle thickness and angles of origin.

Cleft Palate Anatomy (Subjects 3 and 4)

Quantitative measures of the levator muscle for Subjects 3 and 4 are presented in Table 17.

Origin to Origin: The distance between the levator muscle origins increased somewhat from the pre to the postsurgical MRI scan for Subject 3. In the subject with a bilateral cleft lip and palate (Subject 4), the distance was essentially the same, 5.75 cm versus 5.78 cm. The increase in distance between origins likely can be attributed to growth since the levator origins were not altered during surgery. Subject 3 had a greater increase in the distance between the origins compared to Subject 4. This may be due to the fact that seven months had elapsed from the pre to postsurgical MRI scan for Subject 3 whereas Subject 4 had only six months between the two MRI scans.

Subject 3 had a greater distance between levator origins compared to Subject 1 and smaller distance compared to that of Subject 2. Subject 4 displayed an overall greater distance between levator origins compared to the subject with a unilateral cleft lip and palate (Subject 3) and both of the control subjects (Subjects 1 and 2).

Muscle Length: Levator muscle lengths increased from the pre to postsurgical scan by over 1 cm for both the right and left muscle bundles for both subjects with cleft palate (Subjects 3 and 4). Levator muscle lengths in Subject 3a (unilateral cleft lip and palate before surgery) were shorter compared to that of Subjects 1 and 2. Levator muscle lengths in Subject 4a (bilateral cleft lip and palate before surgery) were approximately ¾ cm longer compared to Subject 1 and approximately ½ cm shorter than that observed in Subject 2.

Following surgery, levator muscle lengths in Subject 3b increased in length and were longer than that in Subject 1 and somewhat shorter compared to that of Subject 2. Subject 4b displayed levator muscle lengths that were similar to those observed in Subject 2. Subject 4b had levator muscle lengths that were longer compared to all subjects.

Angles of Origin: Angle of origin measures were obtained in the (a) oblique coronal and the (b) oblique sagittal image planes.

Oblique coronal image plane: Subject 3a (presurgically) exhibited angle of origin measures that were somewhat more acute compared to those observed in Subjects 1 and 2. Following surgery, the angle of origin increased becoming somewhat larger. The angle of origin measures in Subject 3b were more similar to the control subject following surgery compared to the presurgical status. Subject 4a (presurgically) displayed angle of origin measures that were more acute compared to that of Subject 1. Postsurgically, the angles of origin became somewhat larger and became more similar to the measures found in the control subjects. Postsurgically, the angle of origin measurements were more similar between Subjects 3b and 4b compared to the measures obtained presurgically (Subjects 3a and 4a).

Oblique sagittal image plane: The angle of origin measure in the oblique sagittal image plane demonstrated the steepness of the muscle as it converged towards the velum or hard palate. Presurgically, Subjects 3 and 4 displayed angle measures that were somewhat smaller compared to Subjects 1 and 2. Following surgery, the angle of origin measure in the oblique sagittal image plane became somewhat smaller compared to the presurgical state. Both Subject 3 and 4 showed similar measures in both the pre and postsurgical MR images.

Muscle Thickness: Subject 3a (unilateral cleft lip and palate before surgery) displayed muscle thickness measures that were similar to that of Subject 1 and thinner compared to that of Subject 2. Following surgery, the muscle nearly doubled in overall muscle thickness. Postsurgically the muscle was thicker compared to the measures obtained from both Subjects 1 and 2 (control subjects) and the subject with a bilateral cleft lip and palate (Subject 4).

Measures obtained from Subject 4a (bilateral cleft lip and palate before surgery) displayed muscle thickness measures that were somewhat thinner on the right side and somewhat thicker on the left side compared to that of Subjects 1 and 2. Following surgery, the muscle increased minimally in thickness. Compared to Subjects 1 and 2, Subject 4b (after surgery) demonstrated muscle thickness measures that were either similar (right levator muscle) or slightly thicker (left levator muscle).

Subjects with cleft palate showed an increase in levator muscle thickness in the lower half of the muscle following surgery. Whether this is a result of surgical procedures or growth is inconclusive. The levator muscle measures postsurgically for both subjects was comparable to or somewhat thicker compared to that found in the control subjects.

At the time of the presurgical scan, Subject 3 weighed 18 lbs and Subject 4 weighed 8.25 lbs. Unlike the observation found in subjects with a normal mechanism, a larger baby did not result in greater distance between origins or longer levator muscles. The baby's weight did not result in larger levator muscle measures. Subject 4a was most similar in weight to Subject 1 and Subject 3a, 3b, and 4b were most similar to Subject 2. However, measures were not consistently similar between subjects with a similar weight.

Quantitative Measures of the Velopharyngeal Port

Axial and sagittal MR images were used to measure the distance between the velar knee and the posterior pharyngeal wall (FIGS. 11 and 12). The anterior to posterior velopharyngeal port measure was obtained for subjects without cleft palate and subjects with cleft palate before and after surgery. In subjects before cleft palate, the anterior to posterior measure was obtained at both the right and left velar portions. The measurements obtained are reported in Table 18.

Before surgery, the distance from the velum to the posterior pharyngeal wall was greater in distance postsurgically for both subjects with cleft palate. Postsurgically, the distance decreased resulting in a smaller velopharyngeal port opening in the anterior to posterior direction. Subject 4 displayed relatively large adenoid tissue. The resultant MR image displayed irregular tissue boundaries and a small velopharyngeal opening. The distance from the velum to the anterior most region of the adenoid tissue was 0.58 cm. The measurement reported in Table 18 reflects the distance from the velum to the posterior pharyngeal wall rather than to the adenoid pad.

This measurement point was approximated by finding the lateral margins of the adenoid pad, which was determined to be the posterior pharyngeal wall. In addition, in the MR image, the adenoid tissue has a more irregular and granular appearance compared to the smooth single toned appearance of the posterior pharyngeal wall. At the completion of the study, the subject was being evaluated for possible adenoidectomy and tonsillectomy related to suspected sleep apnea. It is also known that the adenoid tissue will atrophy as the child gets older. For all of these reasons, the measurement used for the purposes of the study was the distance from the velum to the posterior pharyngeal wall. The anterior to posterior velopharyngeal port distance in subjects with a repaired cleft palate (Subjects 3b and 4b) was similar to the measures found in the control subjects (Subjects 1 and 2).

Surgical Computer Simulations

A component of the present disclosure was to prove a methodology for creating computer models and surgical simulations based on magnetic resonance images. Following the methods outlined in the previous chapter, 3D computer technology was found to be a valuable and feasible tool for creating 3D computer models of the internal anatomy with specific emphasis on the velopharyngeal mechanism. MRI segmented data were directly imported into Maya and used to create smooth surfaces of the internal structures including the velum, pharynx, skull, hard palate, and levator muscle. The methods were successful in creating an interactive 3D computer model before surgery. The oral and maxillofacial surgeon was able to manipulate the soft tissue structure images one to two weeks before the scheduled surgery date.

A computer animation was created and given to the surgical team one week before the surgery. This was reviewed by the surgical team and used for presurgical planning. Measurements were provided in the computer models to demonstrate the amount of displacement of the muscle suggested by the surgeon during surgical planning. The displacement measurements provided included medial movement of the muscle, length changes in the levator muscle, and posterior movement of the levator sling. Qualitative information could be derived from the model including the type of surgical procedure recommended, the incision lines, an approximate amount of medial displacement of the oral mucosa, and the appearance of the muscle and soft tissue structures at the end of surgery.

The surgical simulations and the displacement measurements can be viewed with 3D computer simulations. These simulations can be used to view movements of the levator muscle alone. The displacement measurements are provided in Tables 19 and 20. The surgical simulation measurements can represent suggested movements described by the surgeon before surgery. As displayed in Tables 19 and 20, the actual displacement changes can be compared to surgical simulations. The actual displacement or changes can be obtained by using a postsurgical computer model to measure the changes in the levator muscle postsurgically. This can be viewed in the pre to postsurgical model simulation using 3D computer models. By comparing the measures reported (surgical simulation and actual displacement) within each Table (19 and 20), inferences can be made regarding the validity of using a surgical planning tool to plan and predict surgical maneuvers.

As demonstrated in Table 19, the suggested changes to be made during the surgical simulation for the subject with a unilateral cleft lip and palate (Subject 3) were similar to the actual displacement. Specifically, the amount of medial muscle movement in the surgical simulation was consistent with the postsurgical muscle changes. The actual muscle length changes observed following surgery were slightly larger compared to what was predicted in the surgical simulation. The posterior movement of the levator muscle was not accounted for entirely in the surgical simulation. Measurements following surgery (actual displacement measures) were nearly double for the right levator muscle and nearly four times the amount for the left levator muscle. Overall, the posterior movement of the muscular sling for Subject 3 was not as accurately represented in the surgical simulations as were the other muscle changes (length and medial movement).

As demonstrated in Table 20, the suggested changes to be made during the surgical simulation for the subject with a bilateral cleft lip and palate (Subject 4) were similar to the actual displacements. In the surgical simulation, the muscle increased in length, moved medially, and posteriorly. The actual displacements were similar, however, the dimensions were somewhat different. There was a greater increase (approximately ½ cm) in muscle length than anticipated during the surgical simulation. The muscle moved 0.8 cm more medially and approximately 0.3 cm more posteriorly than anticipated on the surgical simulation. Overall, the increase in levator muscle length and the posterior movement of the muscular sling for Subject 4 was not as accurately represented in the surgical simulations as was the other muscle change (medial muscle movement).

Comparisons Across 3D Computer Models

3D computer models can be created for subjects with (before and after surgery) and without a cleft palate. A 3D computer animation can be created to demonstrate the surgical simulations that were prescribed by the surgeon. The measures provided in the animation can show the anticipated muscle movements and changes.

A 3D computer animation can also be used to show comparisons to the actual measurements obtained from the pre and postsurgical MR images. The measures provided in the animation can represent the actual muscle changes that were obtained from the MR images. These can be compared to the surgical simulation to demonstrate the feasibility of using a computer reconstruction for planning surgery. As previously mentioned, planned surgical maneuvers can be similar to the actual muscle changes observed in the postsurgical MR images.

Using the MRI data obtained from the control subjects (Subjects 1 and 2), models of normal velopharyngeal anatomy could be created in 3D. Comparisons can then be made across subjects. A visual simulation can be provided that compares the anatomy of the infants with cleft palate to that observed in subjects with normal velopharyngeal anatomy. By viewing the model in three dimensions, the relative size and shapes can be visually appreciated and compared. The added sense of depth can provide the examiner and surgical team an advantage over traditional 2D data (e.g. x-ray).

A child born with a cleft lip and palate may undergo multiple surgeries to approximate normal anatomy and obtain adequate velopharyngeal function for the purposes of speech. Velopharyngeal function is generally adequate for vegetative purposes (swallowing), however, may be inadequate for speech even after primary repair of the palate. When defining the success of surgery, the goal should be to improve speech outcome. A muscle morphology that appears normal yet does not create adequate posterior and superior movement of the velum will have substantial negative effects on speech. Hypernasal speech can, in turn, have negative effects on a child's psychosocial development.

Primary palatal surgery (i.e. primary palatoplasty) is generally performed prior to 18 months of age, preferably during the early stages of speech development. This presents a particular challenge when assessing the speech outcome following surgery. Surgical follow-up assessments are done as soon as speech can be assessed, perhaps as young as two years of age or even younger. Babbling also may provide some indication of the oral to nasal resonance balance. If a child continues to present moderate to severe hypernasality, secondary management options are generally explored.

The primary muscle of interest in velopharyngeal functioning is the levator veli palatini muscle which elevates and retracts the velum to create closure against the posterior pharyngeal wall. In children born with a cleft palate, the levator muscle contracts isometrically due to the bone-to-bone attachment (base of skull to posterior aspect of the hard palate). For most children, pre and postsurgical assessment tools may include nasoendoscopy, videofluoroscopy, and/or lateral view x-ray. None of these methods allow the surgical team to view the levator muscle before or after surgery. As a result, only assumptions about the muscle position, morphology, and function can be made.

Magnetic resonance imaging (MRI) is the only imaging modality that enables visualization of the levator muscle in vivo. This study was designed to use MRI and 3D computer technology to study the levator muscles in infants with cleft palates before and after primary palatoplasty. Quantitative measures of the levator muscle were obtained from two subjects with cleft palate before and after primary palatoplasty. Two controls were used to provide comparisons to normal velopharyngeal anatomy. Three dimensional computer models were created from the MRI data and used to provide comparisons to the pre and postsurgical status and between subjects with and without a cleft palate. The presurgical computer models were used to demonstrate the feasibility and efficiency of the proposed method for patient specific presurgical planning.

Quantitative Measures of the Levator Veli Palatini Muscle

Ettema et al. (2002) found minimal (non-statistically significant) variations in the levator muscle dimensions in the normal (non-cleft) adult population within each gender group. Unlike many other muscles of the human body that vary in size and shape from one individual to the next, based on results from Ettema et al., it appears that the levator muscle is less variable across individuals with normal anatomy. This might suggest that the muscle has an acceptable range of muscle variation that it is considered normal. In such, if the muscle is within this range it will function properly by resulting in velopharyngeal closure. However, if the muscle dimensions are not met, it might be assumed that velopharyngeal function would be compromised.

Ha, Kuehn, Cohen, and Alperin (2007) conducted a similar study, however, using adults with cleft palates. Overall, adults with a repaired cleft palate had shorter and thinner levator muscles compared to the normative measures reported by Ettema et al. (2002). In addition, speech outcomes revealed that some individuals continued to have hypernasal speech. This may serve as preliminary data to confirm the assumption that measurements that are outside of the normal range might yield hypemasal speech. Whether this applies to the infant population is not known. If an acceptable range of levator muscle dimensions could be identified, surgery to reposition the levator muscle could be guided by these parameters. As a result, surgery would not be designed to simply visually approximate normal anatomy, rather it would be to create dimensional changes to the levator muscle that fall within the accepted levator muscle range for the purposes of normal speech.

Results by Kuehn et al. (2004) suggest differences in the levator muscle compared to individuals with a normal mechanism may apply to the infant population. Muscle variations were noted between subjects with cleft palates and compared to an infant with normal anatomy. Results from the present study also demonstrate variations across subjects with cleft palate. In addition, variation was observed in the two subjects with normal anatomy who were one month apart in age.

Normal Velopharyngeal Anatomy

Subjects 1 and 2 demonstrated normal velopharyngeal anatomy. Subjects were one month apart but varied in their weight at the time of the scan. Subjects 1 and 2 displayed variability particularly in the distance between muscle origins and the levator muscle lengths. Subject 2 was a larger baby and displayed measures that were larger (distance between origins, muscle length, and muscle thickness) compared to that of Subject 1. Subject 1 was Asian-Caucasian, where as the remaining subjects were Caucasian. It is known that the cranial and palatal vault size is different among the Asian population compared to that of the non-Asian population (Sugie, Ohba, Mizutani, & Ohno, 1993). Furthermore, the prevalence of clefting is higher in the Asian population compared to Caucasians (Peterson-Falzone, 2001). It may not be presumptuous to assume differences in the musculature in the region of the palate, however, differences in the levator muscle in the Asian population have not been reported. Therefore, caution should be taken in making discrete comparisons between the levator muscle across different races.

The angles of origins in all planes, were fairly consistent between the two subjects showing little variability. Specifically, the muscles showed a similar steepness and convergence towards the midline of the velum. It is not possible to determine if the variation found in the muscle length and distance between origins is statistically significant due to the small sample size. These findings might suggest that variation in the levator dimensions exist as a function of size. Although both subjects displayed levator muscle lengths, thickness, and distance between origins that were dissimilar, it appears that the angles of origin measures were preserved or remained consistent. It is possible that the angle of the muscle as it diverges from the base of the skull might be a critical feature in order to acquire velopharyngeal closure.

Cleft Palate Anatomy

Subjects 3 and 4 were born with a complete cleft of the primary and secondary palate. Subjects were similar in age at the time of the pre and postsurgical MRI scans. Subject 3 weighed twice the amount of Subject 4 at the time of the presurgical scan and was approximately four pounds heavier at the time of the postsurgical scan. Both subjects were 9 months old at the time of primary palatoplasty. Surgical procedures were similar between both subjects with the exception of the vomer flap used for Subject 4. The same surgeon performed both surgeries. Subject 3 was more similar to Subject 2 in size whereas Subject 4 was similar in size before surgery to Subject 1 and after surgery to Subject 2.

Origin to Origin: The distance between levator muscle origins was found to increase for both subjects from the pre to postsurgical MRI scans. This can be attributed to growth as the origins are not altered during surgery.

Muscle Length: In both subjects with cleft palate (Subjects 3 and 4), the levator muscle length increased following surgery. During surgery, the levator muscle bundles are dissected off the hard palate and rotated towards the midline and brought somewhat posteriorly. It is more logical that the retropositioning of the levator muscles would in fact decrease the length of the muscle rather than cause an increase. The postsurgical MRI scans were obtained approximately six to seven months after the presurgical MRI scans. Growth likely attributes to the longer levator muscles observed during the postsurgical MRI data. Another contributing factor, however, was observed by Kuehn et al. (2001).

Using 3D acquisition, the levator muscle was modeled using MRI and manual segmentation. The final model demonstrated a levator sling morphology that followed an oblique coronal direction for the majority of the sling, however, the inferior most region of the muscle curved anteriorly. By using 2D oblique coronal images, as in the present study, the inferior-most region of the muscle may not be appreciated on the MR images. As a result, the muscle that was measured using the oblique coronal sections would appear shorter than the actual muscle length. For the present study, the presurgical muscle length may have been underestimated due to the morphology of the muscle. Postsurgically, however, the muscle may have been measured in its entirety, therefore giving the perception of a muscle increase following surgery.

These findings suggest the need for further research using 3D image acquisition. Using 3D imaging requires longer imaging time compared to 2D acquisition. The imaging time in the previously mentioned study (Kuehn et al., 2002) was approximately 8 minutes. If increasing the imaging time is not possible, measurements of the levator muscle using multiple planes should be explored. By using a 3D software system (e.g. Amira) oblique coronal images can be combined with axial images to visualize the data set in three dimensions to enable accurate measurements using multiple planes.

These findings were not consistent with a previous study by Ha, Kuehn, Cohen, and Alperin (2007) in which adults with a repaired cleft palate overall demonstrated shorter levator muscles compared to the normative measures reported by Ettema et al. (2002). Rather, Subject 4 displayed levator muscle lengths that were longer compared to both subjects with normal velopharyngeal anatomy. Longitudinal studies are needed to determine whether levator muscle growth occurs at the same rate in individuals born with cleft palate versus normals or whether levator growth is retarded.

Angles of Origin: Three angles of origin can be identified when visualizing the levator muscle in three dimensions of space. Although all three measures may prove to be important in the physiology of the muscle, only the angles of origin in the oblique coronal and oblique sagittal image planes were measured for the present study. All three angles, however, will be covered individually.

Oblique coronal image plane: The angles of origins in the oblique coronal image plane in subjects born with a cleft palate became slightly larger following surgery. The angles of origins observed in the postsurgical MRI scans were more similar to those observed in the subjects with a normal mechanism compared to the measures found in the presurgical scans. Infants with a normal velopharyngeal mechanism (Subjects 1 and 2) displayed angles of origins that were between 41 and 45 degrees. Infants born with a cleft palate, presurgically, (Subjects 3a and 4a) displayed measures between 32 and 42 degrees. Postsurgically (Subjects 3b and 4b), the measures were between 39 and 45.5 degrees.

A contributing factor may be due to the irregular muscular sling arrangement observed presurgically. Presurgically, Subjects 3 and 4 displayed a muscle bend (curved region in the lower section of the muscle sling) that was either larger or inverted compared to the muscle bends observed in Subjects 1 and 2. During surgery, the muscle was removed from the hard palate and brought medially to join with the opposing levator sling. The result was a muscle morphology and muscle bend that was similar to that observed in subjects with normal velopharyngeal anatomy. This shift of the muscle may have caused the muscle bend to become somewhat larger.

Oblique sagittal image plane: The angles of origin in the oblique sagittal image plane became somewhat smaller following surgery. The angle following surgery was also smaller compared to that of Subjects 1 and 2. It was expected that this angle measure would in fact become larger, resulting in a muscle that was more vertically oriented rather than horizontally. By dissecting the muscle off the hard palate, it is assumed that the sling would be positioned in a lower and more posterior position following surgery. Although the muscle did appear to be dissected off the hard palate it did not assume this position. The observation of a smaller angle of origin in the oblique sagittal image plane may be due to the surgical procedure being used.

A radical dissection of the levator muscle fibers from the hamulus as well as from the hard palate, theoretically, should result in a more “V” shaped levator sling (Court Cutting, Md., personal communication). In addition, if fibers are not radically dissected around the hamulus, a few fibers may remain attached to the hard palate and prevent the muscle from dropping into a more vertically oriented position. A muscle that is shaped in more of “V” might be beneficial in providing a better elevating leverage compared to a more “U” shaped levator sling that might be found when some of the levator fibers are still attached to the hamulus. Further comparative MRI studies will be important in addressing this issue.

Axial image plane: FIG. 38 displays the angle of origin in the axial plane. From a top down view the angle of the muscle as it heads towards the midline can be visualized. The angle displays the amount of convergence of the muscle bundles. A muscle bundle that converges very sharply would display a small axial angle of origin and would be disadvantageous for drawing the velum posteriorly. The angle of origin in the axial image plane is more difficult to obtain compared to the previous angles of origin measures. In order to predict the axial angle of origin, the volume within which the levator muscle is contained must be known. Measurements and reconstructions of the levator muscle were conducted using two dimensional images, which makes analysis of the third angle of origin difficult.

Muscle Thickness: There was little variation in the muscle thickness measures between subjects with normal velopharyngeal anatomy and those born with a cleft palate. The muscle thickness increased following surgery and in some cases was slightly thicker compared to that of the control subjects. These findings are not consistent with the finding reported by Ha, Kuehn, Cohen, and Alperin (2007) which found adults born with a cleft palate to have thinner muscles compared to the normative measures reported by Ettema et al. (2002). As for muscle length, a longitudinal study measuring levator muscle thickness as a function of age would be important to address this issue.

Muscle thickness was measured at the region of the muscle bend in order to eliminate the interference of the musculus uvulae. By measuring at the muscle bend, the thickness measure was intended to represent the levator muscle alone. However, the muscle was difficult to delineate from the surrounding tissue structures in this particular region. Furthermore, this measurement site may overlap with the palatoglossus and palatopharyngeus muscles as they insert into the lateral aspects of the velum. Although this may prove to be a more favorable site for measurement, other means for assessing the muscle thickness should be explored in subsequent studies.

Quantitative Measures of the Velopharyngeal Port

Measurements of the anterior to posterior velopharyngeal port were combined with the quantitative levator muscle dimensions to provide a better understanding of the velopharyngeal mechanism in infants born with a cleft palate. Measurements were obtained before and after surgery and compared to measurements obtained from two subjects born with normal velopharyngeal anatomy (Subjects 1 and 2). Results indicated that postsurgically, the anterior to posterior dimensions were similar to those observed in Subjects 1 and 2. Following surgery, the distances decreased compared to the presurgical distance for both subjects with cleft palate. These results are promising in that it demonstrates a similar velopharyngeal port opening dimension to that observed in individuals without a cleft palate.

The goal of surgery is to approximate normal anatomy for the purposes of promoting velopharyngeal closure. In both subjects with cleft palate, the muscle was completely dissected off the hard palate and retropositioned to join with the opposing levator muscle. This movement of the levator muscle posteriorly assists in bringing the reconstructed velum towards the posterior pharyngeal wall. Subject 4 had a greater posterior movement of the levator muscle (approximately 0.6 cm) during surgery compared to that in Subject 3. Interestingly, Subject 4 displayed a smaller distance between the velum and the posterior pharyngeal wall postsurgically. Whether this is directly correlated is inconclusive, however, this might suggest a connection to the amount of posterior movement of the levator during surgery with a smaller velopharyngeal orifice. A smaller anterior to posterior velopharyngeal opening will assist in closure of the velum against the posterior pharyngeal wall if the levator muscle is functioning properly.

The effects of gravity while the subject is in supine position in the MRI scanner will cause smaller anterior to poster velopharyngeal measures. Therefore, these measurements should only serve as comparisons to similar measures taken while the infant is supine.

Presurgical Computer Simulations

The presurgical MRI scan was used to construct 3D computer models of infants with cleft palate before surgery. The computer models were then used with the surgeon to interactively manipulate the soft tissue structures prior to the scheduled surgery date. A short animation of the projected muscle and soft tissue movements was created and viewed by the surgical team one week before surgery. Levator muscle changes were provided in the animations to show the actual displacements in centimeters. These measurements were compared with the actual dimensions observed in the MRI six to seven months following the presurgical MRI scan. Overall, the surgical simulations were similar to the actual muscle changes observed in the follow-up MRI. The posterior movement of the levator muscle was underestimated in the surgical simulation for both subjects.

During surgical planning, the posterior pharyngeal wall was generally made transparent or not included in the computer model in order to fully view the area of interest (hard palate, oral mucosa, velum, and levator muscle). In addition, the anterior to posterior velopharyngeal opening measure was not included in the surgical planning. In future surgical computer simulations, the posterior pharyngeal wall should be included. By providing visualization of the distance between the velum and the posterior pharyngeal wall the surgeon might more accurately determine the posterior movement of the levator muscle. As previously indicated, the posterior movement of the levator may have significant implications on the velopharyngeal orifice.

The computer simulations were successful in estimating the movements of the levator and velum when performed by an experienced surgeon. The animations were also used to teach surgical residents the procedures involved in palatal surgery. Viewing anatomy in 3D outside of the operating room provides significant advantages. The surgeon was able to view the anatomy as it existed in three dimensions and among the surrounding structures. The distance between the velum and the posterior pharyngeal wall could be visually appreciated. The surgical simulation could then be used to observe the postsurgical status prior to the surgery. The surgeon could confirm that the movements prescribed and the dimensional changes recommended would result in a velopharyngeal mechanism that visually approximated the anatomy observed in the normal infant computer model.

MRI proved to a viable input data source for use in 3D software programs for the creation of 3D computer simulated surgeries. The method used in this study provided a means to assess the pre and postsurgical status and to chart surgical maneuvers before entering the operation room. There are numerous advantages to the development of a surgical simulation for cleft palate surgeries. If further research concludes an acceptable range for the levator muscle in the normal mechanism, a computer simulation could be designed to automatically manipulate the muscle to fit those parameters. Actual levator muscle measurements could then guide the surgeon in the placement of the muscle during surgery. As a result, surgical planning is directed by functional anatomy (improving the mechanism for function) rather than just by anatomy alone (creating a muscle that looks normal).

Clinical Implications

By combining MRI and 3D computer technology, presurgical planning focusing on the major muscles of the velopharynx can be realized. Imaging modalities, such as MRI, provide more useful information during surgical planning compared to computerized tomography (CT). This is because MRI allows for visualization of the major muscle of velar elevation (levator muscle) and the soft tissue of the velopharyngeal mechanism.

Presurgical planning tools such as described in the present disclosure are advantageous for numerous reasons. First, it allows the surgeon to view the internal anatomy before the scheduled surgery. This is especially beneficial for surgical repair of a cleft palate where the primary muscle is deep and cannot be viewed through an oral examination or palpating the surface. Second, surgical planning allows the surgeon to interactively manipulate the hard and soft tissue structures before surgery. Computer graphics are steadily improving and with new software developments, the properties of soft tissue (e.g. tensile, elastic, etc) may be more accurately reflected in computer models. Further, computer surgical planning tools are particularly useful in training surgical residents outside of the operation room. Because computer modeling can be displayed on a standard laptop or desktop, training can also be extended to developing countries. Although the surgical planning tool designed in this research is not refined or sophisticated enough for some of these proposed surgical applications, it is a step closer.

The present disclosure also demonstrates the use of patient specific diagnosing, treating, and follow-up. The clinical implications of this approach (MRI and computer modeling) to treating individuals with a cleft lip and palate are significant. By using MRI and computer technology, patient specific diagnosing, treating, and follow-up may improve the prognosis and surgical outcomes for individuals born with a cleft palate. In the area of diagnosing, the methods used in this study provide a view of the internal anatomy and may require few assumptions to be made. Conducting patient specific follow-up analyses using MRI and computer modeling, the success of surgery may be appreciated. This may also help guide future recommendations regarding speech therapy and the need for subsequent surgeries.

The results of the present disclosure demonstrate the successful use of a method for creating patient specific diagnosing, treating, and conducting follow-up assessments for children born with a cleft palate. The present disclosure shows the use of 3D computer technology and MRI in creating surgical planning tools for primary palatoplasty, and has demonstrated the use of surgical planning to improve surgical outcomes and provide a better means for assessing pre and postsurgical status of the primary muscle for velar elevation. The present disclosure illustrates a means for virtual reality analysis of cleft palate surgery.

Generally speaking the present disclosure provides a means for 3D simulation of any surgical procedure on a patient before the patient undergoes actual surgery. Physicians can explore different simulated 3D surgical models on a patient to determine which best suits the patient's needs. The present disclosure can also be applied to postsurgical analysis as described above. It should be noted that the manual steps taken to demonstrate the results of the present disclosure can be automated by common software development techniques thus providing a physician a tool (or set of tools) to analyze MRI data of a patient in the form of simulated presurgical exploratory and physiological analysis, simulated analysis of an application of one or more surgical procedures, and simulated postsurgical exploratory and physiological analysis. These advancements can prevent costly and painful surgical iterations that can physiologically and psychologically harm a patient.

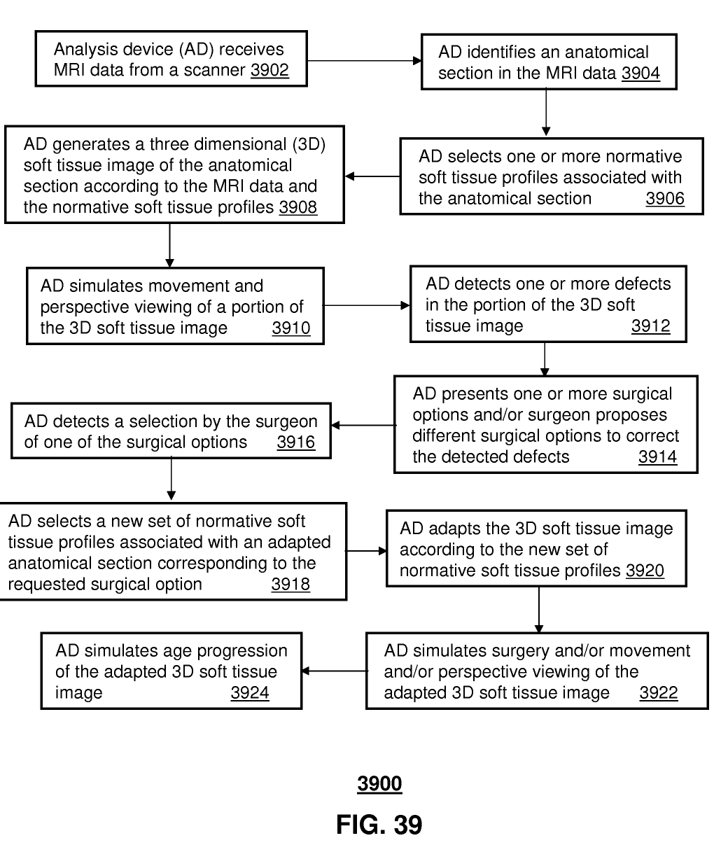

FIG. 39 depicts an illustrative embodiment of a method 3900 which describes in general terms the applications of the present disclosure. Method 3900 can begin with step 3902 in which a computing device such as a server, mainframe, desktop computer, or other form of computing resource operating as an analysis device receives MRI data from a common MRI scanner. The MRI data can be derived from an MRI screening of one or more anatomical sections of a patient (human or animal). The analysis device can be programmed in step 3904 to sort the MRI data (as described above) according to an image plane and a corresponding coordinate of said plane. Once the sorting process is complete, the analysis device can be programmed to identify an anatomical section in the MRI data to be analyzed. This step can be performed by common image processing and pattern detection techniques as described earlier in the disclosure.

For example, suppose the anatomical section is the head and throat sections of the patient. The analysis device can be programmed to access a reservoir (or database) of profiles of different anatomical sections of the human body or a species of animal to identify one or more anatomical sections in the MRI data of step 3902. The database can organize the profiles by gender, age, weight, height, race, and so on to increase the probability of a successful identification of an anatomical section. Alternatively, a physician or technician can direct the analysis device to search for a specific anatomical section based on a knowledge of the portions of the patient that were scanned.

Once one or more anatomical sections are identified in step 3904, the analysis device can select in step 3906 one or more normative soft tissue profiles associated with said anatomical section to generate in step 3908 a three dimensional (3D) soft tissue image as was illustratively described earlier. The normative soft tissue profiles can be retrieved by the analysis device from a database that can also be organized according gender, age, weight, height, race, health of sample, and other suitable characteristics that can be helpful in extrapolating a 3D soft tissue image of the anatomical section of the patient. The normative profiles can be based on a sampling pool of other patients who have been scanned by an MRI scanner. The pool of scanned patients can provide a statistical sampling pool that can be used by common imaging technology to construct a 3D soft tissue image of the patient in question.

In step 3910, the analysis device can be directed to simulate movement and perspective viewing of a portion of the 3D soft tissue image. The portion selected can be located anywhere in the 3D soft tissue image including cross sections with semi-transparent sections. A physician can direct the analysis device to simulate an opening and closing of the patient's mouth. The physician can also request an exploratory view that begins from the patient's mouth traversing down through the esophagus while perhaps the analysis device simulates the patient engaged in speech or swallowing tasks. During simulations, the analysis device can also draw on the resources of normative soft tissue profiles of healthy patients to detect any abnormalities in the patient being analyzed.

From the detected defects, the analysis device can present in step 3914 a selection of one or more surgical options to correct the detected defects. This step can represent the analysis device indexing a database of surgical procedures according to the detected defects. Each defect can be associated with one or more surgical options. A surgeon can also suggest in the same step one or more surgical options not shown in the list of options presented by the analysis device. When a surgeon selects one of the surgical options presented by the analysis device or requests a different surgical technique in step 3916, the analysis device can proceed to step 3918 where it identifies a new set of normative soft tissue profiles associated with an adapted anatomical section resulting from the selected or requested surgical procedure. The new identified set of normative soft tissue profiles can be associated with patients who have undergone the proposed surgical procedure to be simulated. To provide a reasonably accurate simulation, the normative soft tissue profiles of the adapted anatomical section can be organized by age, gender, weight, height, or other dimensions suitable to approximate a match to the physiological features of the patient in question.

In step 3920, the analysis device can adapt the 3D soft tissue image generated in step 3908 according to the new set of normative soft tissue profiles to extrapolate imaging data that emulates the application of a surgical procedure on the patient. The simulated surgery can be presented in step 3922 by the analysis device on a step-by-step basis so that the physician can visualize the procedure and identify complexities in the process. After the virtual surgery is completed, the analysis device can be programmed to simulate the patient's expected prognosis from the surgery.

For example in the case of an application of a cleft palate surgical procedure, the analysis device can be directed to simulate a movement of the patient's mouth, simulated eating, simulated speech, simulated lip movement, and so on. In addition, the analysis device can be directed in step 3924 to simulate an age progression of the adapted 3D soft tissue image. In the cleft palate example the age progression can be determined from a statistical pool of normative soft tissue profiles of patients of progressive ages (e.g., 7 years of age, 8 years of age, 9 years of age and so on) with a similar cleft palate condition as the patient as well as normal patients of progressive ages to determine how the adapted 3D soft tissue image might change over the course of a defined period.

MRI scanning can also be conducted on older siblings and applied to the pool of subject profiles used for that specific individual. This would further allow for more accuracy by including genetic components to the morphological changes anticipated with growth projections. Speech, eating or other common functions can also be simulated at different stages of the age progression.

Portions of method 3900 can be applied repetitively by a physician until satisfactory results have been identified in simulated pre and post surgery. The results of method 3900 can also be used by the physician to guide an actual surgical procedure.

From the foregoing descriptions, it would be evident to an artisan with ordinary skill in the art that the aforementioned embodiments can be modified, reduced, or enhanced without departing from the scope and spirit of the claims described below. Other suitable modifications can be applied to the present disclosure. Accordingly, the reader is directed to the claims for a fuller understanding of the breadth and scope of the present disclosure.

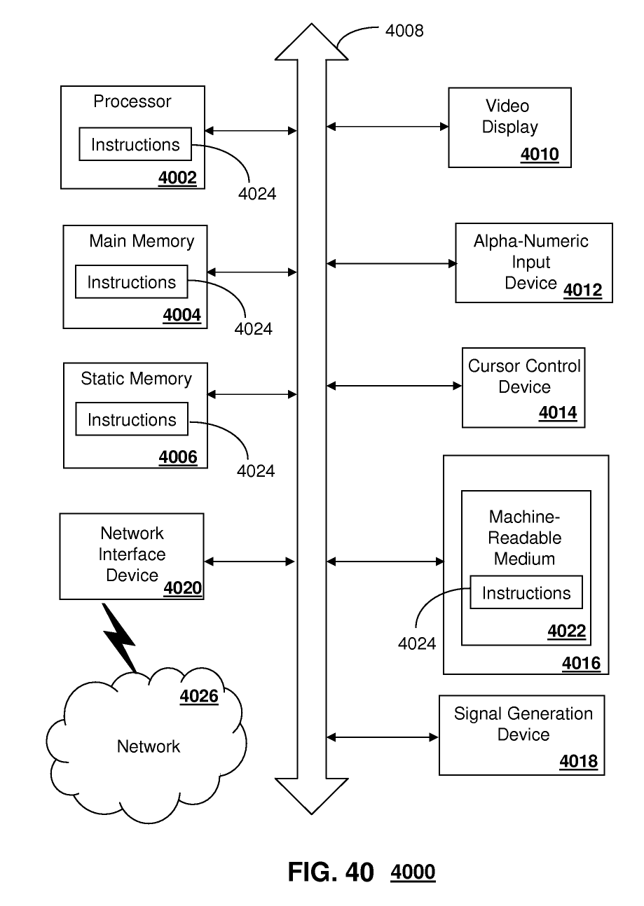

FIG. 40 depicts an exemplary diagrammatic representation of a machine in the form of a computer system 4000 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 4000 may include a processor 4002 (e.g., a central processing unit (CPU), a graphics processing unit (GPU, or both)), a main memory 4004 and a static memory 4006, which communicate with each other via a bus 4008. The computer system 4000 may further include a video display unit 4010 (e.g., a liquid crystal display (LCD), a flat panel, a solid state display, or a cathode ray tube (CRT)). The computer system 4000 may include an input device 4012 (e.g., a keyboard), a cursor control device 4014 (e.g., a mouse), a disk drive unit 4016, a signal generation device 4018 (e.g., a speaker or remote control) and a network interface device 4020.

The disk drive unit 4016 may include a machine-readable medium 4022 on which is stored one or more sets of instructions (e.g., software 4024) embodying any one or more of the methodologies or functions described herein, including those methods illustrated above. The instructions 4024 may also reside, completely or at least partially, within the main memory 4004, the static memory 4006, and/or within the processor 4002 during execution thereof by the computer system 4000. The main memory 4004 and the processor 4002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 4024, or that which receives and executes instructions 4024 from a propagated signal so that a device connected to a network environment 4026 can send or receive voice, video or data, and to communicate over the network 4026 using the instructions 4024. The instructions 4024 may further be transmitted or received over a network 4026 via the network interface device 4020.

While the machine-readable medium 4022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

### REFERENCES

Abe, M., Murakami, G., Noguchi, M., Kitamura, S., Shimada, K., & Kohama, G. (2004). Variations in the tensor veli palatini muscle with special reference to its origin and insertion. Cleft Palate-Craniofacial Journal, 41(5), 474-484.
Azzam, N. A., & Kuehn, D. P. (1977). The morphology of musculus uvulae. Cleft Palate Journal, 14, 78-87.
Baer, T., Gore, J., Gracco, L., & Nye, P. (1991). Analysis of vocal tract shape and dimensions using magnetic resonance imaging. Journal of Acoustical Society of America, 90, 799-828.
Barsoumain, R., Kuehn, D., Moon, J., & Canady., J. (1988). An anatomic study of the tensor veli palatini and dilator tubae muscles in relation to Eustachian tube and velar function. Cleft Palate-Craniofacial Journal, 35, 101-110.
Berry, D., Moon, J., & Kuehn, D. (1999). A finite element model of the soft palate. Cleft Palate-Craniofacial Journal, 36, 217-223.
Carter, E., Friedman, H., & Bischoff, J. (2005). Cranio facial reconstructive surgery with graphically interfaced cephalometry. 2005 Summer Bioengineering Conference, Vail Cascade Resort and Spa, Vail, Colo.
Cassell, M., Moon J., & Elkadi, H. (1990). Anatomy and physiology of the velopharynx. Multidisciplinary management of cleft lip and palate. Philadelphia: Saunders.
Cutting, C., Oliker, A., Haring, J., Dayan, J., & Smith, D. (2002). Use of three-dimensional computer graphic animation to illustrate cleft lip and palate surgery. Computer Aided Surgery, 7(6), 326-331.
Cutting, C., Rosenbaum, J., & Rovati, L. (1995). The technique of muscle repair in the soft palate. Operative Techniques in Plastic Reconstructive Surgery, 2, 215-222.
Dang, J., & Honda, K. (1997). Acoustic characteristics of the pyriform fossa in models of humans. Journal of Acoustical Society of America, 101, 456-465.
Dickson, D. R., & Dickson, W. M. (1972). Velopharyngeal anatomy. Journal of Speech and Hearing Research 15, 372-381.
Ettema, S., Kuehn, D., Perlman, A., & Alperin, N. (2002). Magnetic resonance imaging of the levator veli palatini muscle during speech. Cleft Palate-Craniofacial Journal, 39(2), 130-144.
Ettema, S., & Kuehn, D. (1994). A quantitative histologic study of the normal human adult soft palate. Journal of Speech and Hearing Research, 37, 303-313.
Finkelstein, Y., Shapiro-Feinberg, M., Talmi, Y., Nachamani, A., DeRowe, A., & Ophir, D. (1995). Axial configuration of the velopharyngeal valve and its valving mechanism. Cleft Palate Craniofacial Journal, 32(4), 299-305.
Finkelstein, Y., Gerger, G., Nachmani, A., & Ophir D. (1996). The functional role of the adenoids in speech. International Journal of Pediatric Otorhinolaryngology, 34(1-2), 61-74.
Fritzell, B. (1969). The velopharyngeal muscles in speech. Acta Otolaryngology, 250 (Supplement), 1-81.
Greenwood, A., Goodyear, C., & Martin, P. (1992). Measurements of vocal tract shapes using magnetic resonance imaging. IEEE Proceedings., 139, 553-560.
Ha, S., Kuehn, D., Cohen, M., & Alperin, N. (in press). Magnetic resonance imaging of the levator veli palatini muscle in speakers with a repaired cleft palate. The Cleft Palate-Craniofacial Journal.
Huang, M., Lee, S., & Rajendran, K. (1998). Anatomic basis of cleft palate and velopharyngeal surgery: implications from a fresh cadaveric study. Plastic and Reconstructive Surgery, 101(3), 613-627.
King, S., & Parent, R. (2005). Creating speech-synchronized animation. IEEE Transactions on Visualization and Computer Graphics, 11(3), 341-352.
Kock, K., Grzonka, M., & Koch, J. (1999). The pathology of the velopharyngeal musculature in cleft palates. Annals Anatomy, 181(1), 123-126.
Kuehn, D. (1979). Velopharyngeal anatomy and physiology. Ear, Nose, and Throat Journal, 58(7), 316-321.
Kuehn, D. & Azzam, N. (1978). Anatomical characteristics of palatoglossus and the anterior faucial pillar. Cleft Palate Journal, 15, 349-359.
Kuehn, D., Ettema, S., Goldwasser, M., Barkmeier, J., & Wachtel, J. (2001). Magnetic resonance imaging in the evaluation of occult submucous cleft palate. Cleft Palate-Craniofacial Journal, 38, 421-431.
Kuehn, D., Moon, J., Canady, J., Bolinger, L., & Cook-Granroth, J. (2001). Assessment of velopharyngeal musculature using 3D MRI acquisition and reformatting software analysis. 9^{th} International Congress on Cleft Palate and Related Craniofacial Anomalies, Gothenburg, Sweden.
Kuehn, D., Ettema, S., Goldwasser, M., & Barkmeier, J. (2004). Magnetic resonance imaging of the levator veli palatini muscle before and after primary palatoplasty. Cleft Palate-Craniofacial Journal, 41(6), 584-592.
Kuehn, D., Folkins, J., & Linville, R. (1988). An electromyographic study of the musculus uvulae. Cleft Palate Journal, 25(4), 348-355.
Kuehn, D., & Kahane, J. (1990). Histologic study of the normal human adult soft palate. Cleft Palate Journal, 27(1), 26-34.
Kuehn, D., & Moon, J. (2005). Histologic study of intravelar structures in normal human adult specimens. Cleft Palate-Craniofacial Journal, 42, 481-489.
Kuehn, D., & Perry, J. (in press) Anatomy and Physiology of the Velopharynx. Comprehensive Cleft Care. Columbus: McGraw-Hill.
Landsdown, R., & Polak, L. (1975). A study of the psychological effects of facial deformity in children. Child Care Health Development, 4, 85-91.
McGowan, J., Hatabu, H., Yousem, D., Randall, P., Kressel, H. (1992). Evaluation of soft palate function with MRI: application to the cleft palate patient. Journal of Computer Assisted Tomography, 16, 877-882.
McWilliams, B. (1990). The long term speech results of primary and secondary surgical correction of palatal clefts. In Bardach., J. and Morris, H. L. (Eds), Multidisciplinary Management of Cleft Lip and Palate. Philadelphia, W.B. Sauders.
Mehendale, F. (2004). Surgical anatomy of the levator veli palatini: a previously undescribed tendinous insertion of the anterolateral fibers. Plastic and Reconstructive Surgery, 114(2), 307-315.
Moon, J. B., & Kuehn, D. P. (2004). Anatomy and physiology of normal and disordered velopharyngeal function for speech, in Bzoch K R (ed.): Communicative Disorders Related to Cleft Lip and Palate, 5^{th} ed. (pp. 67-98). Austin, Tex.: Pro-Ed.
Moon, J., Smith, A., Folkins, J., Lemke, J., & Gartlan, M. (1994). Coordination of velopharyngeal muscle activity during positioning of the soft palate. Cleft Palate Journal, 31, 44-55.
Nakasima, A., Terajima, M., Mori, N., Hoshino, Y., Tokumori, K., Aoki, Y., & Hashimoto, S. (2005). Three-dimensional computer-generated head model reconstructed from cephalograms, facial photographs, and dental cast models. American Journal of Orthodontics and Dentofacial Orthopedics, 127(3), 282-293.
Narayanan, S., Alwan, A., & Haker, K. (1997). Toward articulatory-acoustic models for liquid approximants based on MRI and EPG data. Part I. The laterals. Acoustical Society of America, 101, 1064-1077.
Perlman, A., Luschei, E., & Du Mond, C. (1989). Electrical activity from superior pharyngeal constrictor during reflexive and nonreflexive tasks. Journal of Speech and Hearing Research, 32(4), 749-754.
Perlman, A. L., & Schulze-Delrieu, K. (1997). Deglutition and its Disorders (Eds.). San Diego: Singular Publishing Group.
Perry, J., & Kuehn, D. (2006). Using cadavers for teaching anatomy of the speech and hearing mechanisms. ASHA Leader. September issue.
Perry, J., & Kuehn, D. (2007). Three-Dimensional Computer Reconstruction of the Levator Veli Palatini Muscle in Situ Using Magnetic Resonance Imaging. Journal of Cleft-Palate Craniofacial Anomalies, 44(4), 421-423.
Perry, J., Kuehn, D., & Langlois, R. (2007). Teaching anatomy of the speech mechanisms through computer based stereoscopic images. Journal of College Science Teaching, 36(4), 18-23.
Peterson-Falzone, S., Hardin-Jones, M., and Karnell, M. (2001). Cleft Palate Speech. Mosby, Inc. St. Louis, Mich.
Seaver, E., & Kuehn, D. (1980). A cineradiographic and electromyographic investigation of velar positioning in non-nasal speech. Cleft Palate Journal, 17, 216-226.
Sommerlad, B., Henley, M., Birch, M., Harland, M., Moiemen, N., & Boorman, J. (1994). Cleft palate re-repair—a clinical and radiographic study of 32 consecutive cases. British Journal of Plastic Surgery, 47, 406-410.
Sommerlad, B., Mehendale, F., Birch, M., Sell, D., Hattee, C., & Harland, K. (2002). Palate re-repair revisited. Cleft Palate Craniofaical Journal, 39, 295-311.
Spauwen, P., Hillen, B., Lommen, E., & Otten, E. (1991). Three-dimensional computer reconstruction of the Eustachian tube and paratubal muscles. Cleft Palate-Craniofacial Journal. 28(2), 217-220.
Sugie, M., Ohba, H., Mizutani, M., and Ohno, N. (1993). Hard palate shape in the Japanese and Indian children on moiré topography with lateral movement of a grafting. Kaibogaku Zasshi, 68(5), 522-535.
Trigos, I., Ysunza, A., Vargas, D., & Vazquez, M. (1988). The San Venero Roselli pharyngoplasty: an electromyographic study of the palatopharyngeus muscle. Cleft Palate Journal, 25, 163-166.
Vadodaria, S., Goodacre T., & Anslow, P. (2000). Does MRI contribute to the investigation of palatal function? British Journal of Plastic Surgery, 53(3), 191-199.
Villamil, A., Nedel, L., Freitas, C., & Maciel, A. (2005). A model to simulate the mastication motion at the temporomandibular joint. SPIE International Society of Optical Engineering, 5746 (303), 303-313.
Wein, B., Drobnitzky, M., Klajman, S., & Angerstein, W. (1991). Evaluation of functional positions of tongue and soft palate with MR imaging: initial clinical results. Journal of Magnetic Resonance Imaging, 1, 381-383.
Yamawaki, Y., Nishimura, Y., Suzuki, Y., Sawada, M., & Yamawaki, S. (1997). Rapid magnetic resonance imaging for assessment of velopharyngeal muscle movement on phonation. American Journal of Otolaryngology, 18, 210-213.

TABLE 1

| | | Subject Number | | | |
|---|---|---|---|---|---|
| | | 1 | 2 | 3 | 4 |
| Gender | | Female | Female | Female | Male |
| Age | (a) | 9 months | 10 months | (a) 8 months | (a) 8 months |
| | (b) | | | (b) 15 months | (b) 14 months |
| Weight | (a) | 8.15 lbs | 22 lbs | (a) 18 lbs | (a) 8.25 lbs |
| | (b) | | | (b) 22.25 lbs | (b) 18.25 lbs |

| | | | | |
|---|---|---|---|---|
| Ethnicity | Asian/ | Caucasian | Caucasian | Caucasian |
| | Caucasian | | | |
| Cleft Type | NA | NA | Unilateral cleft | Bilateral cleft lip |
| | | | lip and palate | and palate |
| Age at Lip Repair | NA | NA | 10 weeks | 9 weeks |
| Age at Primary | NA | NA | 9 months | 9 months |
| Palatoplasty | | | | |
| Other Medical | Moderate to | History of | NA | NA |
| Information | severe hearing | seizures | | |
| | loss | | | |

TABLE 2

| | 1.5 Tesla System: | 3 Tesla System: |
|---|---|---|
| Type of scan: | fast spin echo (FSE) | turbo spin echo (TSE) |
| TR and TE: | minimum TE | TE: 9.5, TR 400 ms |
| | TR 400 ms | |
| Slice thickness: | 5 mm | 5 mm |
| Spacing: | 1.0 mm | 1.0 mm |
| Field of view: | 22 cm | 22 cm |
| Approximate scan | 2½ minutes | 2½ minutes |
| time: | | |
| Number of slices: | 16 to 17 | 16 to 17 |
| Matrix: | 512 × 512 | 512 × 512 |

TABLE 3

| | 1.5 Tesla System: | 3 Tesla System: |
|---|---|---|
| Type of scan: | fast spin echo (FSE) | turbo spin echo (TSE) |
| TR and TE: | TE 17 ms, TR 3000 ms | TE 17 ms, TR 3000 ms |
| Slice thickness: | 1.5 mm | 1.5 mm |
| Spacing: | 0 mm | 0 mm |
| Field of view: | 16 cm | 16 cm |
| Approximate scan | 2½ minutes/plane | 2½ minutes/plane |
| time: | | |
| Number of slices: | 23 to 24 | 23 to 26 |
| Matrix: | 256 × 256 | 256 × 256 |

TABLE 4

| | 1.5 Tesla System: | 3 Tesla System: |
|---|---|---|
| Type of scan: | fast spin echo (FSE) | turbo spin echo (TSE) |
| TR and TE: | TE 14.9 ms | TE 14.9 ms |
| | TR 3000 ms | TR 3000 ms |
| Slice thickness: | 2 mm | 2 mm |
| Spacing: | 0 mm | 0 mm |
| Field of view: | 20 cm | 20 cm |
| Approximate scan | 7½ minutes | 7½ minutes |
| time: | | |
| Matrix: | 256 × 256 | 256 × 256 |
| Number of Slices | 28 | 28 |

TABLE 5

| Type of scan: | turbo spin echo |
|---|---|
| TR and TE: | TE 2.48 ms |
| | TR 250 ms |
| Slice thickness: | 2 mm |
| Spacing: | .9 mm |
| Number of slices: | 20 |

TABLE 6

| Type of scan: | T2 FLAIR |
|---|---|
| TR and TE: | TE 92 ms |
| | TR 9,000 ms |
| Slice thickness: | 4.8 mm |
| Spacing: | 0 mm |
| Number of slices: | 27 |

TABLE 7

| Type of scan: | turbo spin echo |
|---|---|
| TR and TE: | TE 114 ms |
| | TR 750 ms |
| Slice thickness: | .6 mm |
| Spacing: | .3 mm |
| Number of slabs: | 1 |

TABLE 8

| Type of scan: | turbo spin echo |
|---|---|
| TR and TE: | TE 22 ms |
| | TR 3,000 ms |
| Slice thickness: | 1.5 mm |
| Spacing: | 0 mm |
| Number of slices: | 29 |

TABLE 9

| Type of scan: | turbo spin echo |
|---|---|
| TR and TE: | TE 2.48 ms |
| | TR 250 ms |
| Slice thickness: | 5.0 mm |
| Spacing: | 1 mm |
| Number of slices: | 20 |

TABLE 10

| Type of scan: | T2 FLAIR |
|---|---|
| TR and TE: | TE 92 ms |
| | TR 9,000 ms |
| Slice thickness: | 5.0 mm |
| Spacing: | 0 mm |
| Number of slices: | 20 |

TABLE 11

| Type of scan: | coronal magnitude |
|---|---|
| TR and TE: | TE 45 ms |
| | TR 5,000 ms |
| Slice thickness: | 3.0 mm |
| Spacing: | .3 mm |
| Number of slabs: | 20 |

TABLE 12

| Type of scan: | MPRAGE |
|---|---|
| TR and TE: | TE 2.29 ms |
| | TR 2,400 ms |
| Slice thickness: | 1.5 mm |
| Spacing: | 0 mm |
| Number of slices: | 29 |

TABLE 13

| Type of scan: | diffuse weighted |
|---|---|
| TR and TE: | TE 78 ms |
| | TR 5,000 ms |
| Slice thickness: | 1 mm |
| Spacing: | 0 mm |
| Number of slices: | 27 |

TABLE 14

| Type of scan: | turbo spin echo |
|---|---|
| TR and TE: | TE 22 ms |
| | TR 3,000 ms |
| Slice thickness: | 1.5 mm |
| Spacing: | 0 mm |
| Number of slices: | 29 |

TABLE 15

| Tool | Tool Description |
|---|---|
| Magic Wand | Selects through region growing either in 2D or 3D. After selecting a voxel, |
| | the largest connected area that contains the voxel itself and |
| | all voxels with gray values lying inside a user-defined range will be |
| | selected. A threshold can be selected to modify the region selection |
| | and gray scale value of interest |
| Paint Brush | Selects regions by painting voxels with left mouse held down. Size |
| | of brush can be modified to include number of voxels of interest. |
| Blow Tool | The user selects a voxel and drags the mouse without releasing the |
| | button. A selection area forms in the shape of a circle between the |
| | selected voxels in areas where gray values are homogeneous. |
| Active Contour | The user selects points along the boundary of the area of interest |
| | and a contour line will create a boundary using the points. The area |
| | inside the contour lines and the line itself is selected. |
| Lasso Tool | Defines an area by generating a closed contour curve. Contour can |
| | be drawn freehand or by creating a fence with line segments. |
| | Contour boundary is closed and selection within the line segments |
| | is selected. |

TABLE 16

| | Subject 1 | Subject 2 |
|---|---|---|
| Measure | (9-mo) | (10-mo) |
| Origin to Origin | 3.84 cm | 5.58 cm |
| Length | | |
| Right | 2.91 cm | 3.86 cm |
| Left | 2.92 cm | 4.05 cm |
| Angles of Origin | | |
| Oblique coronal (R; L) | 45°; 42.9° | 41°; 42.6° |
| Oblique sagittal | 48° | 42.7° |
| Thickness | | |
| Right | .28 cm | .37 cm |
| Left | .23 cm | .23 cm |

TABLE 17

| | Subject 3a | Subject 3b | Subject 4a | Subject 4b |
|---|---|---|---|---|
| Measure | (8-mo) | (15-mo) | (8-mo) | (14-mo) |
| Origin to Origin | 4.31 cm | 4.74 cm | 5.75 cm | 5.78 cm |
| Length | | | | |
| Right | 2.23 cm | 3.41 cm | 3.4 cm | 4.2 cm |
| Left | 2.26 cm | 3.28 cm | 3.2 cm | 4.04 cm |
| Angles of Origin | | | | |
| Oblique | 34.7°; 42.4° | 39.0°; 44.4° | 32°; 36.5° | 41.4°; 45.5° |
| coronal(R; L) | | | | |
| Oblique sagittal | 49.4° | 37.8° | 42.2° | 39.4° |
| Thickness | | | | |
| Right | .23 cm | .44 cm | .27 cm | .30 cm |
| Left | .18 cm | .35 cm | .30 cm | .36 cm |

TABLE 18

| | Anterior-posterior |
|---|---|
| Subject | Measure |
| Subject 1 | 1.15 cm |
| Subject 2 | 1.01 cm |
| Subject 3 | |
| (a) before | |
| surgery | |
| Right | 1.65 cm |
| Left | 1.61 cm |
| (b) after surgery | 1.11 cm |
| Subject 4 | |
| (a) before | |
| surgery | |
| Right | 1.38 |
| Left | 1.35 |
| (b) after surgery | .96 cm |

TABLE 19

| | Surgical | Actual |
|---|---|---|
| | Simulation | Displacement |
| Muscle length | | |
| changes | | |
| Right | 3.12 cm | 3.41 cm |
| Left | 3.1 cm | 3.28 cm |
| Medial movement of | | |
| the muscle | | |
| Right | .78 cm | .79 cm |
| Left | .78 cm | .79 cm |
| Posterior movement | | |
| of the muscle sling | | |
| Right | .04 cm | .17 cm |
| Left | .17 cm | .32 cm |

TABLE 20

| | Surgical | Actual |
|---|---|---|
| | Simulation | Displacement |
| Muscle length | | |
| changes | | |
| Right | 3.60 cm | 4.2 cm |
| Left | 3.54 cm | 4.04 cm |
| Medial movement of | | |
| the muscle | | |
| Right | .76 cm | .84 cm |
| Left | .76 cm | .84 cm |
| Posterior movement | | |
| of the muscle sling | | |
| Right | .33 cm | .59 cm |
| Left | .33 cm | .61 cm |

TABLE 21
Origin to origin measurements (in cm) for all subjects

| | | Measurement | | |
|---|---|---|---|---|
| | | Number | | |
| | | 1 | 2 | 3 |
| Subject 1 | Rater 1 | 3.84 | 3.91 | 4.0 |
| | Rater 2 | 3.93 | 4.23 | 3.73 |
| Subject 2 | Rater 1 | 5.58 | 5.53 | 5.51 |
| | Rater 2 | 5.54 | 5.54 | 5.47 |
| Subject 3a | Rater 1 | 4.31 | 4.34 | 4.34 |
| | Rater 2 | 4.37 | 4.34 | 4.36 |
| Subject | Rater 1 | 4.74 | 4.75 | 4.74 |
| 3b | Rater 2 | 4.76 | 4.74 | 4.72 |
| Subject 4a | Rater 1 | 5.75 | 5.73 | 5.74 |
| | Rater 2 | 5.76 | 5.71 | 5.71 |
| Subject | Rater 1 | 5.78 | 5.79 | 5.76 |
| 4b | Rater 2 | 5.79 | 5.77 | 5.77 |

TABLE 22
Length measurements (in cm) for all subjects

| | | | Measurement | | |
|---|---|---|---|---|---|
| | | | Number | | |
| | | | 1 | 2 | 3 |
| Subject 1 | Rater 1 | (R) | 2.91 | 2.93 | 2.84 |
| | | (L) | 2.92 | 3.01 | 3.18 |
| | Rater 2 | (R) | 2.92 | 2.99 | 2.78 |
| | | (L) | 3.03 | 3.10 | 2.94 |
| Subject 2 | Rater 1 | (R) | 3.86 | 3.74 | 3.89 |
| | | (L) | 4.05 | 4.14 | 4.11 |
| | Rater 2 | (R) | 3.78 | 3.73 | 3.74 |
| | | (L) | 4.14 | 4.07 | 3.99 |
| Subject 3a | Rater 1 | (R) | 2.23 | 2.22 | 2.22 |
| | | (L) | 2.26 | 2.21 | 2.30 |
| | Rater 2 | (R) | 2.33 | 2.18 | 2.19 |
| | | (L) | 2.28 | 2.22 | 2.25 |
| Subject 3b | Rater 1 | (R) | 3.41 | 3.46 | 3.35 |
| | | (L) | 3.28 | 3.31 | 3.6 |
| | Rater 2 | (R) | 3.4 | 3.39 | 3.41 |
| | | (L) | 3.27 | 3.23 | 3.27 |
| Subject 4a | Rater 1 | (R) | 3.4 | 3.16 | 3.39 |
| | | (L) | 3.2 | 3.4 | 3.31 |
| | Rater 2 | (R) | 3.21 | 3.2 | 3.22 |
| | | (L) | 3.12 | 3.53 | 3.41 |
| Subject 4b | Rater 1 | (R) | 4.2 | 4.0 | 4.2 |
| | | (L) | 4.04 | 4.1 | 4.1 |
| | Rater 2 | (R) | 4.21 | 4.18 | 4.1 |
| | | (L) | 4.17 | 4.09 | 4.13 |

TABLE 23
Angle of origin measurements (in degrees) for the oblique
coronal image plane across all subjects

| | | | Measurement | | |
|---|---|---|---|---|---|
| | | | Number | | |
| | | | 1 | 2 | 3 |
| Subject 1 | Rater 1 | (R) | 45 | 44 | 48.6 |
| | | (L) | 42.9 | 41.1 | 43.1 |
| | Rater 2 | (R) | 45.3 | 47.9 | 47 |
| | | (L) | 42.5 | 43.1 | 48.6 |
| Subject 2 | Rater 1 | (R) | 41 | 44.2 | 42.4 |
| | | (L) | 42.6 | 41.3 | 41.9 |
| | Rater 2 | (R) | 43.5 | 48 | 46.8 |
| | | (L) | 43.1 | 49.9 | 46.3 |
| Subject 3a | Rater 1 | (R) | 34.7 | 38.3 | 42.7 |
| | | (L) | 42.4 | 42.7 | 40.4 |
| | Rater 2 | (R) | 36.6 | 37.4 | 37.3 |
| | | (L) | 42.3 | 47.4 | 46.4 |
| Subject 3b | Rater 1 | (R) | 39 | 40 | 39.1 |
| | | (L) | 44.4 | 41.2 | 38.8 |
| | Rater 2 | (R) | 38.5 | 38.3 | 44.4 |
| | | (L) | 39.4 | 37.1 | 40.8 |
| Subject 4a | Rater 1 | (R) | 32 | 31.6 | 34 |
| | | (L) | 36.5 | 37.7 | 35.4 |
| | Rater 2 | (R) | 32.9 | 34.7 | 40.1 |
| | | (L) | 36.7 | 36.2 | 41.3 |
| Subject 4b | Rater 1 | (R) | 41.4 | 43.6 | 41.6 |
| | | (L) | 45.5 | 45.2 | 43.6 |
| | Rater 2 | (R) | 36.3 | 39.1 | 44.9 |
| | | (L) | 40 | 40.9 | 46.5 |

TABLE 24
Thickness measurements (in cm) for all subjects

| | | | Measurement | | |
|---|---|---|---|---|---|
| | | | Number | | |
| | | | 1 | 2 | 3 |
| Subject 1 | Rater 1 | (R) | .28 | .28 | .27 |
| | | (L) | .23 | .21 | .22 |
| | Rater 2 | (R) | .29 | .27 | .28 |
| | | (L) | .18 | .21 | .22 |
| Subject 2 | Rater 1 | (R) | .37 | .27 | .27 |
| | | (L) | .23 | .19 | .18 |
| | Rater 2 | (R) | .25 | .27 | .26 |
| | | (L) | .18 | .19 | .19 |
| Subject 3a | Rater 1 | (R) | .23 | .24 | .25 |
| | | (L) | .18 | .19 | .20 |
| | Rater 2 | (R) | .22 | .25 | .24 |
| | | (L) | .15 | .18 | .18 |
| Subject 3b | Rater 1 | (R) | .44 | .40 | .43 |
| | | (L) | .35 | .36 | .39 |
| | Rater 2 | (R) | .44 | .43 | .43 |
| | | (L) | .35 | .34 | .35 |
| Subject 4a | Rater 1 | (R) | .27 | .31 | .29 |
| | | (L) | .30 | .36 | .32 |
| | Rater 2 | (R) | .28 | .27 | .29 |
| | | (L) | .31 | .33 | .34 |
| Subject 4b | Rater 1 | (R) | .30 | .34 | .34 |
| | | (L) | .36 | .37 | .37 |
| | Rater 2 | (R) | .29 | .30 | .33 |
| | | (L) | .38 | .36 | .36 |

What is claimed is:

1. A computer-readable storage medium, comprising computer instructions for:
receiving Magnetic Resonance Image (MRI) data;
identifying an anatomical section in the MRI data;
selecting one or more normative soft tissue profiles associated with the anatomical section; and
generating a three dimensional (3D) soft tissue image of the anatomical section from the MRI data and the one or more normative soft tissue profiles selected.

2. The storage medium of claim 1, wherein the one or more normative soft tissue profiles are associated with muscle tissue.

3. The storage medium of claim 1, wherein the anatomical section is associated with at least a portion of a velopharynx of a patient.

4. The storage medium of claim 3, comprising computer instructions for sorting the MRI data according to an image plane and a corresponding coordinate of said image plane.

5. The storage medium of claim 3, comprising computer instructions for adjusting the MRI data to align with an oblique coronal plane to identify soft tissue associated with the velopharynx.

6. The storage medium of claim 3, wherein the one or more normative soft tissue profiles correspond to a normal velopharynx.

7. The storage medium of claim 3, wherein the one or more normative soft tissue profiles correspond to an abnormal velopharynx.

8. The storage medium of claim 7, wherein the abnormal velopharynx corresponds to a cleft palate.

9. The storage medium of claim 1, comprising computer instructions for selecting the one or more normative soft tissue profiles from a reservoir of normative soft tissue profiles categorized by at least one among age, gender, or race.

10. The storage medium of claim 9, wherein the reservoir of normative soft tissue profiles is determined from a plurality of patients.

11. The storage medium of claim 1, comprising computer instructions for:
receiving a request to apply a surgical procedure to the 3D soft tissue image;
selecting a new set of one or more normative soft tissue profiles associated with an adapted anatomical section corresponding to the selected surgical procedure; and
adapting the 3D soft tissue image according to the new set of one or more normative soft tissue profiles.

12. The storage medium of claim 11, comprising computer instructions for simulating movement and perspective viewing of the adapted 3D soft tissue image.

13. The storage medium of claim 3, comprising computer instructions for:
simulating movement in the 3D soft tissue image in relation to the portion of the velopharynx;
detecting one or more defects in the velopharynx; and
identifying the one or more defects in the 3D soft tissue image.

14. The storage medium of claim 13, comprising computer instructions for detecting the one or more defects from a comparison of the simulated movement of the 3D soft tissue image to the one or more normative soft tissue profiles of a normal velopharynx.

15. The storage medium of claim 13, wherein the simulated movement corresponds to simulated speech, and wherein the storage medium comprises computer instructions for presenting an audio simulation of the simulated speech.

16. The storage medium of claim 13, comprising computer instructions for presenting one or more surgical options to correct at least one among the one or more defects.

17. The storage medium of claim 1, comprising computer instructions for selecting the one or more normative soft tissue profiles according to at least one among gender, age, and race.

18. A method, comprising generating a three dimensional (3D) image by comparing Magnetic Resonance Image (MRI) data associated with an anatomical section with one or more normative profiles.

19. The method of claim 18, wherein the 3D image corresponds to one among a presurgical 3D image or post-surgical 3D image of the anatomical section.

20. The method of claim 18, wherein the 3D image corresponds to one among a 3D still image, and a 3D animated image.

21. The method of claim 18, comprising:
collecting MRI data of a plurality of patients, wherein the MRI data is associated with soft tissue of the anatomical section;
normalizing the MRI data collected from at least a portion of the plurality of patients; and
creating a reservoir of normative profiles of soft tissue from the normalized MRI data.

22. The method of claim 21, comprising selecting the one or more normative profiles used to generate the 3D image from the reservoir of normative profiles

23. The method of claim 18, comprising predicting an age progression of the 3D image.

24. The method of claim 23, comprising presenting an animation of the 3D image according to the predicted age progression.

25. An imaging device, comprising a Magnetic Resonance Image (MRI) scanner to generate MRI data associated with soft tissue of a patient, and supply said MRI data to diagnostic equipment that selects one or more normative soft tissue profiles of a select anatomical section, and generates a three dimensional (3D) soft tissue image from the MRI data and the one or more normative soft tissue profiles.
